(19) United States
(12) Patent Application Publication
(10) Pub. No.: US 2026/0087484 A1
(43) Pub. Date: Mar. 26, 2026

(54) DECOUPLED GIFT CARDS AND PROCESS FOR ACTIVATION AND VALIDATION

(71) Applicant: Target Brands, Inc., Minneapolis, MN (US)

(72) Inventors: Christopher Brakob, Minneapolis, MN (US); Lucas Keith Struck, Golden Valley, MN (US); Ryan Andrew Pekarek, Cottage Grove, MN (US); Miguel Herrera, Fillmore, CA (US); Sunil Pai Kasturi, Blaine, MN (US)

(21) Appl. No.: 19/338,515

(22) Filed: Sep. 24, 2025

Related U.S. Application Data
(60) Provisional application No. 63/699,575, filed on Sep. 26, 2024.

(51) Int. Cl. G06Q 20/34; G06Q 20/20; G06Q 20/26

(52) U.S. Cl. CPC G06Q 20/341; G06Q 20/204; G06Q 20/26; G06Q 20/354

(57) ABSTRACT

Disclosed are systems, methods, and techniques for purchasing and activating a decoupled gift card. A system can include: a first gift card component of a first type having a first identifier, a second gift card component of a second type separate from the first component and having a second identifier, the second component being configured to attach to the first component to form a decoupled gift card purchasable during a checkout process, a point of sale (POS) terminal that scans the first and second identifiers during checkout, and a remote computer system that can activate the decoupled gift card while the checkout process is performed. The remote system can receive the scanned identifiers, identify a gift card number corresponding to the first scanned identifier, identify an access token corresponding to the second scanned identifier, and associate the gift card number with the access token to activate the decoupled gift card.

### INCORPORATION BY REFERENCE

This application claims the priority benefit of U.S. Provisional Patent Application No. 63/699,575, filed Sep. 26, 2024, the entire contents of which are incorporated by reference in their entirety.

### TECHNICAL FIELD

This disclosure generally describes devices, systems, apparatuses, and methods related to decoupled gift card components that are configured to be assembled at or during a checkout process in a retail environment, such as a store, to validate and activate the gift cards for usage.

### BACKGROUND

Physical gift cards have often been made of a plastic material and include a pre-generated unique card number used to identify the card and to redeem the stored value associated with the card. Such pre-generated unique card numbers can be generated and printed on gift cards prior to their placement on a shelf or other retail display, and prior to the gift card being purchased during a retail checkout process.

To provide added security, gift cards have often been pre-generated to include a PIN or other validating identifier that is paired with the unique gift card number and used to validate purchases made with the gift card. For example, the gift card can be printed or otherwise generated with the card number and the PIN, and then put on a shelf in a retail environment, such as a store. The card number and/or the PIN can sometimes be exposed while on display on the shelf. Sometimes, the gift card may be printed with a message, images, or other information on a surface of the card.

When a retail customer purchases the gift card, the card number can be scanned, the purchase of the gift card can be verified, and then the gift card can be activated for redemption by presenting the card number in combination with the PIN. Sometimes, the PIN can be physically covered on the card with a protective film or other tamper-proof material that can prevent the PIN from being viewed unless the film or other tamper-proof material is at least partially removed. To reveal or otherwise view the PIN, a customer may scratch off the film or other tamper-proof material.

### SUMMARY

The disclosure generally describes devices, systems, apparatuses, and methods related to decoupled gift card components that are configured to be assembled/attached to each other around or during a checkout process in a retail environment, such as a store, to form a completed/coupled gift card that can be validated, activated and used at one or more retailers. More specifically, a decoupled gift card, which may be incomplete and insufficient for activation by itself, can be placed on shelves or other retail stands for selection by a guest or customer in the retail environment. At checkout, the guest, or a team member (e.g., employee) in the retail environment, can be prompted to apply one or more additional components, such as one or more labels, to the decoupled gift card to form a completed/coupled gift card capable of activation. Unique identifiers (e.g., barcodes) on the decoupled gift card and/or additional components (e.g., one or more labels configured to be affixed to the decoupled gift card) can be scanned and provided to a remote computing system (e.g., backend server system). The remote computing system can be configured to identify and associate these decoupled gift card components with each other to establish an activated gift card. Activation information, such as an access code that associates the decoupled gift card with one or more other components (e.g., one or more labels), can be provided by a point-of-sale (POS) terminal during the checkout process to the remote computing system to validate the gift card and add funds to the card. Sometimes, the activation information can be provided by the remote computing system to the POS terminal during the checkout process in order to validate the gift card and/or add funds to the card. In some implementations, the unique identifier of the gift card and/or the label can be a pointer to a PIN or other unique identifying value that is maintained by the remote computing system. For example, the unique identifier on the label can be a pointer or token to retrieve a corresponding access code that is stored in a data store by the remote computing system. When associating the gift card with the label, the remote computing system can identify the access code that corresponds to the label and provide that access code as part of the activation information for the gift card.

The disclosed techniques provide both physical and technology-based infrastructure configured to retain and provide access to physical and digital gift cards once a decoupled gift card is validated and activated—providing an infrastructure for retailers to validate and activate decoupled gift cards for use at other retailers or gift card network systems. For example, this infrastructure can provide for a broker or a configuration at third party systems that is updated with access code tokens and gift card number pairings, which can then be used to validate transactions with third party services. This infrastructure allows for the disclosed techniques to be applied in various use cases. For example, these techniques can be applied where a retail environment sells a decoupled gift card associated with a third party, which can then be exchanged for a redeemable digital third party gift card. As another example, these techniques can be applied where the retail environment sells a decoupled third party gift card that can be used (either physically or electronically) with a third party retailer. These techniques can additionally or alternatively be applied where a third party sells a decoupled gift card that is associated with another retail environment, which can then be exchanged for a redeemable digital gift card for the other retail environment. Similarly, these techniques can be applied where the third party sells a decoupled gift card associated with the other retail environment, which can be redeemed and used directly at the other retail environment. Various other use cases are also possible, as described further herein.

One or more embodiments described herein can include a system for purchasing and activating a decoupled gift card in a retail store, the system including: a first gift card component of a first type, the first gift card component including a first identifier, a second gift card component of a second type that can be different from the first type, the second gift card component being separate from the first gift card component and including a second identifier, the second gift card component being configured to be attached to the first gift card component to form a decoupled gift card that can be purchasable during a checkout process, a point of sale (POS) terminal that can be configured to scan the first identifier and the second identifier during the checkout process, and a remote computer system in network communication with the POS terminal and that can be configured to activate the decoupled gift card while the checkout process is performed at the POS terminal. The remote computer system can be configured to perform operations including: receiving, from the POS terminal, the scanned identifiers for the decoupled gift card, identifying a gift card number corresponding to the first scanned identifier, identifying an access token corresponding to the second scanned identifier, associating the gift card number with the access token to activate the decoupled gift card, and transmitting, to the POS terminal, an indication that the decoupled gift card has been activated. The POS terminal can be configured to complete the checkout process for purchasing the activated decoupled gift card.

In some implementations, the embodiments described herein can optionally include one or more of the following features. For example, the second gift card component can include one or more labels. The first identifier can include a barcode that points to the gift card number that can be maintained in a data entry of a data table in a data store. The data entry corresponding to the gift card number can include an indication that the first gift card component has an inactive status. The second identifier can include a barcode that can point to the access token that can be maintained in a data entry of a data table in a data store. The data entry corresponding to the access token can include an indication that the second gift card component has an inactive status. The data entry corresponding to the access token can include the access code.

In some implementations, associating the gift card number with the access token can include generating a data entry in a data table maintained in a data store that identifies the first gift card component and the second gift card component as the decoupled gift card, the data entry identifying the decoupled gift card as activated. The checkout process can be performed at a first retail store, and the decoupled gift card can be used during a subsequent checkout process at a second retail store. The first retail store and the second retail store can be part of a same retailer network. The first retail store and the second retail store can be part of different retailer networks. The first gift card component can include a physical gift card that can be associated with a third party retail store. The third party retail store can be different than a retail store where the checkout process is performed. The third party retail store can be the same as the retail store where the checkout process is performed. The first gift card component can include a physical gift card that, once activated, can be useable in any retail network.

As another example, a mobile device of a user can be configured to communicate with the remote computer system to redeem the decoupled gift card and the remote computer system can be further configured to perform operations including: receiving a request from the mobile device for a digital gift card, the request including the gift card number of the decoupled gift card, identifying an association between the gift card number of the decoupled gift card and the digital gift card, and transmitting information that includes the digital gift card to the mobile device of the user, the transmitted information including at least an access code for the digital gift card. The system further can include a second POS terminal in a second retail store and the second POS terminal can be configured to: scan, using a scanning device at the second POS terminal, the digital gift card at the mobile device of the user, and in response to scanning the digital gift card, transmit a request to the remote computer system to validate the digital gift card. The remote computer system can be further configured to perform operations including: validating that the digital gift card is associated with the activated decoupled gift card and in response to validating the digital gift card, transmitting validation information to the second POS terminal. The second POS terminal can be configured to, in response to receiving the validation information, complete a checkout process at the second POS terminal using the digital gift card as a form of payment. Sometimes, the second gift card component can be common across multiple retailers. Sometimes, the first gift card component can be different across multiple retailers. The first gift card component and the second gift card component can be different across multiple retailers.

One or more embodiments described herein can include a method for purchasing and activating a decoupled gift card, the method including: receiving a decoupled gift card activation call from a POS terminal in a retail store, the activation call including a gift card number and an access token, validating the gift card number in an inactive gift card table, validating the access token in an access token table, inserting the gift card number and an access code associated with the access token into an active gift card table, the access code being retrieved from the access token table, where inserting the gift card number and the access code into the active gift card table can include designating a decoupled gift card and identifying the decoupled gift card as active, and transmitting a pre-authorization success notification to the POS terminal. Based on receiving the pre-authorization success notification, the POS terminal can be configured to complete a purchase process of the decoupled gift card.

The method can optionally include one or more of the abovementioned features and/or one or more of the following features. For example, the method can further include updating a status of the gift card number in the inactive gift card table to an active status. The method can include updating a status of the access token in the access token table to an active status. The method can include updating the inactive gift card table by removing the gift card number from the inactive gift card table. The method may include updating the access token table by removing the access token from the access token table.

In some implementations, the decoupled gift card can include a physical gift card and a label. The label can be affixed to the physical gift card during the purchase process of the decoupled gift card. The gift card number can be printed on a surface of the physical gift card and the access token can be printed on a surface of the label. The label further can include the access code printed thereon. The label further can include a scratch off material that can be configured to overlay the access code to hide the access code from view until the purchase process is completed. Sometimes, the method can also include: receiving a request from a mobile device for a digital gift card, the request including the gift card number of the physical gift card, identifying an association between the gift card number of the physical gift card and the digital gift card, and transmitting information that includes the digital gift card to the mobile device, the transmitted information including at least an access code for the digital gift card. The method can also include: receiving a request from a second POS terminal in a second retail store to validate the digital gift card, the second POS terminal can be configured to scan, using a scanning device at the second POS terminal, the digital gift card at the mobile device, and in response to scanning the digital gift card, transmit the request to validate the digital gift card.

One or more embodiments described herein can include a method for purchasing and activating a decoupled gift card, the method including: receiving a request to activate a decoupled gift card from a POS terminal in a retail store, the request including a first identification value and a second identification value, validating the first identification value and the second identification value as inactive in a data store, designating the decoupled gift card based on associating the first identification value with an access code that corresponds to the second identification value, and returning, based on the designating, information indicating that the decoupled gift card has been activated.

The method can optionally include one or more of the abovementioned features and/or one or more of the following features. For example, the first identification value can include a gift card number. Validating the first identification value can include identifying the gift card number in a data entry of an inactive gift card table in the data store. The second identification value can include an access token. Validating the second identification value can include identifying the access token in a data entry of an access token table in the data store. Designating the decoupled gift card can include inserting the first identification value and the access code that corresponds to the second identification value into an active gift card table. Designating the decoupled gift card can include identifying a status of the decoupled gift card as an active status. Returning the information can include transmitting the information to the POS terminal, the POS terminal being configured to complete a purchase process of the decoupled gift card in response to receiving the information. The first identification value can be affixed to a first gift card component of the decoupled gift card and the second identification value can be affixed to a second gift card component of the decoupled gift card. The first gift card component can be a physical gift card and the second gift card component can be a label. The label can be affixed to a designated area of the physical gift card during the purchase process of the decoupled gift card. In some implementations, the method may further include: receiving a request from a mobile device for a digital gift card, the request including the first identification value, identifying an association between the first identification value and the digital gift card, and transmitting information that includes the digital gift card to the mobile device, the transmitted information including at least an access code for the digital gift card. The method may also include: receiving a request from a second POS terminal in a second retail store to validate the digital gift card, the second POS terminal being configured to scan, using a scanning device at the second POS terminal, the digital gift card at the mobile device, and in response to scanning the digital gift card, transmit the request to validate the digital gift card.

The devices, system, and techniques described herein may provide one or more of the following advantages. For example, the disclosed technology can limit or otherwise prevent an ability of malicious actors to steal or otherwise compromise gift card information, such as PINs, and subsequently drain card funds upon activation of those cards. This disclosed technology requires a customer or team member at a retail environment to attach two decoupled gift components, a gift card and a label, to each other during a checkout process, where each component has identifying information. Scanning the unique identifying information for each of the components during the checkout process allows for the components to be validated and associated with each other in a backend or remote computing system such that the gift card can be activated. Moreover, one or more of the identifying information can be tokens or pointers to actual access information for the component(s). As a result, the access information can only become known once the backend computing system has validated and associated the components with each other to provide a redeemable gift card (whether physical or digital). This can ensure additional security of the redeemable gift card to limit or otherwise prevent malicious users from compromising gift card information and draining associated funds. The disclosed technology can also improve customer experiences with the retail environment for the reasons mentioned above.

As another example, the disclosed technology provides a comprehensive plug-and-play infrastructure of both physical and technology-based components that can be easily adopted and implemented in many different retail environments. This infrastructure allows for purchase, activation, and validation of physical and digital gift cards at the different retail environments. This infrastructure also allows for redemption of the physical and digital gift cards at the different retail environments through a seamless, integrated remote/backend computing system providing secure checks and validations of the physical and digital gift cards.

Decoupling the components (e.g., a gift card and a security token or label) can ensure that even if a bad actor obtains one of the components (e.g., a physical gift card), that obtained component remains useless without the corresponding component (e.g., a label with an access code). Conventional techniques often rely on protective coatings (e.g., scratch off materials covering PINs or other unique identifiers and codes), which can be easily tampered with. The disclosed techniques, on the other hand, minimize the risk of theft and fraud before a sale is finalized by preventing the bad actor from tampering with components of a gift card. The disclosed techniques also provide additional advantages and security on a backend from a technological perspective. For example, the backend system can apply fraud detection algorithms and monitor transaction behavior in real-time to detect and block suspicious activities across retail networks. The backend can also cross-check transactions against databases of known bad actors or suspicious IP addresses to prevent activation of a gift card if a match is not found. Moreover, the backend system can monitor for abnormal activities, such as flagging unusual patterns (e.g., multiple activation attempts or rapid transactions, potential bot attacks, automated fraud attempts). The backend system may also perform real-time fraud prevention by acting as a gatekeeper, blocking and/or delaying suspicious activities during transactions across the retail networks to prevent fraud before it occurs.

The details of one or more implementations are set forth in the accompanying drawings and the description below. Other features and advantages will be apparent from the description and drawings, and from the claims.

### BRIEF DESCRIPTION OF THE DRAWINGS

FIG. 1A is a conceptual diagram of a system for activating and validating decoupled gift cards.

FIG. 1B is a conceptual diagram of a system for activating a decoupled gift card at a first retail environment and redeeming the decoupled gift card at a second retail environment.

FIG. 1C is a conceptual diagram of a system for redeeming a digital gift card for use at a retail environment.

FIG. 1D illustrates an example gift card display in a retail environment.

FIG. 2 is a conceptual diagram of a system for activating a decoupled gift card during a checkout process.

FIGS. 3A, 3B, and 3C illustrate example techniques for associating information of decoupled gift card components with each other to activate the decoupled gift card.

FIG. 4 is a block diagram of a process for activating a decoupled gift card.

FIG. 5 illustrates an example decoupled gift card.

FIG. 6 is a conceptual diagram of a system for purchasing a decoupled gift card at a POS terminal in a retail environment.

FIG. 7 is a flowchart of a process for authorizing purchase of a decoupled gift card.

FIGS. 8A and 8B illustrate an example barcode and access label of a decoupled gift card.

FIG. 9 is a conceptual diagram of a system for authorizing a gift card purchase during a checkout process.

FIG. 10 is another conceptual diagram of a system for authorizing a gift card purchase during a checkout process.

FIG. 11 is a schematic diagram that shows an example of a computing device and a mobile computing device.

In the present disclosure, like-numbered components of various embodiments generally have similar features when those components are of a similar nature and/or serve a similar purpose, unless otherwise noted or otherwise understood by a person skilled in the art.

### DETAILED DESCRIPTION OF ILLUSTRATIVE EMBODIMENTS

This disclosure generally relates to systems, methods, apparatus, and techniques for decoupled stored value card components (e.g., gift card components) that are configured to be assembled and activated at or during a checkout process in a retail environment. A decoupled gift card can include a two-part card composed of a gift card printed with a unique identifier, such as a gift card number, and a second part, such as a label, which can be applied at time of sale. Although the label is described herein, the second part of the decoupled gift card can be any other part that can be combined with or affixed to the gift card, including but not limited to an envelope, a wrapper, a sleeve, etc. The label can have a unique identifier, such as a token, that relates to an access code that may also be printed on the label but hidden from sight (e.g., by a scratch off material). These decoupled gift card components can be semi-randomly combined at time of sale to improve security by making the access code associated to the gift card unpredictable and unexposed before completion of the sale. The unique identifiers can be scanned at a POS terminal during checkout and provided to a remote computing system. The remote computing system can associate the values with each other to validate and activate the decoupled gift card and then provide the access code relating to the label back to the POS terminal for completion of the sale/checkout process. Once the sale is completed, the decoupled gift card is activated and can be used at the retail environment selling the decoupled gift card components or at third party retailers.

The disclosed techniques can be applied in a variety of different use cases. As an illustrative example, a secure decoupled physical gift card for a third party can be issued in a retail environment (where the retail environment is not associated with the third party). This gift card may not be directly redeemable, but can be exchanged online for a secure digital gift card, which can then be redeemable at retail environments associated with the third party. As another example, the disclosed techniques can be used where a secure decoupled physical gift card is issued by a third party for either the third party or other retail environments not associated with the third party. This gift card may not be directly redeemable and instead can be exchanged online for a secure digital gift card that can be redeemed at either the retrial environments associated with the third party or other retail environments. As another illustrative example, a secure decoupled physical gift card for a third party can be issued in a retail environment that is not associated with the third party and directly redeemable at another retail environment that is associated with the third party. The disclosed techniques can be used, as another example, where a secure decoupled physical gift card is issued by a third party for a retail environment associated with the third party or other retail environments. This gift card can be directly redeemed at either of the retail environments.

Traditionally, a gift card can include a PIN that is covered with a protective film but otherwise identifiable/locatable on the card. A user may scratch off the protective film to view the PIN, which allows the user to make purchases with the gift card as a form of payment. Some malicious users have begun taking gift cards off the shelves before the gift cards are purchased and activated, and going to an offsite location where the malicious users remove the protective films, recording the PINs in association with the gift card numbers (or other combinations of identifying information that is pre-generated on the gift cards) into a system, reapplying the protective films, and then put the gift cards back on the shelves in the retail store. The intention of this scheme is to make the protective film or other tamper-proof material that has been reapplied to the cards appear authentic and original so that other, legitimate users within the store proceed to purchase the cards using the processes described above. While these recorded and compromised gift cards are on the shelves, the malicious users are polling online gift card systems using the recorded gift card number and PIN numbers (or other unique identifiers) until they are purchased and activated by the legitimate users, at which point the online gift card systems return a positive response to the polling queries by the malicious users. Once a positive response is received, the malicious users transfer and/or use the stored value associated with the gift cards to another account—effectively draining the stored value associated with the gifts cards without the knowledge of the legitimate user. Then, the purchasing users (and/or other users receiving the gift cards) cannot utilize the gift cards because the bad actors who scratched off the protective films and recorded the PINs have already drained the funds from the now-activated gift cards using the previously-recorded identifying information (e.g., combination of gift card numbers and PINs).

The disclosed technology addresses these concerns and other gift card scams by providing a physical implementation of gift card and label components having respective identifying information (e.g., barcodes, SKUs) that, when affixed to each other, allow for scanning the identifying information to securely activate the gift card for use with various different retail environments.

While the following disclosure is provided with regard to decoupled gift cards, the disclosure is broadly applicable to stored value cards, which includes gift cards, prepaid cards (e.g., closed system prepaid cards, semi-closed system prepaid cards), and other types of payment cards with a monetary value stored on or in association with the card itself instead of an external account maintained by a financial institution.

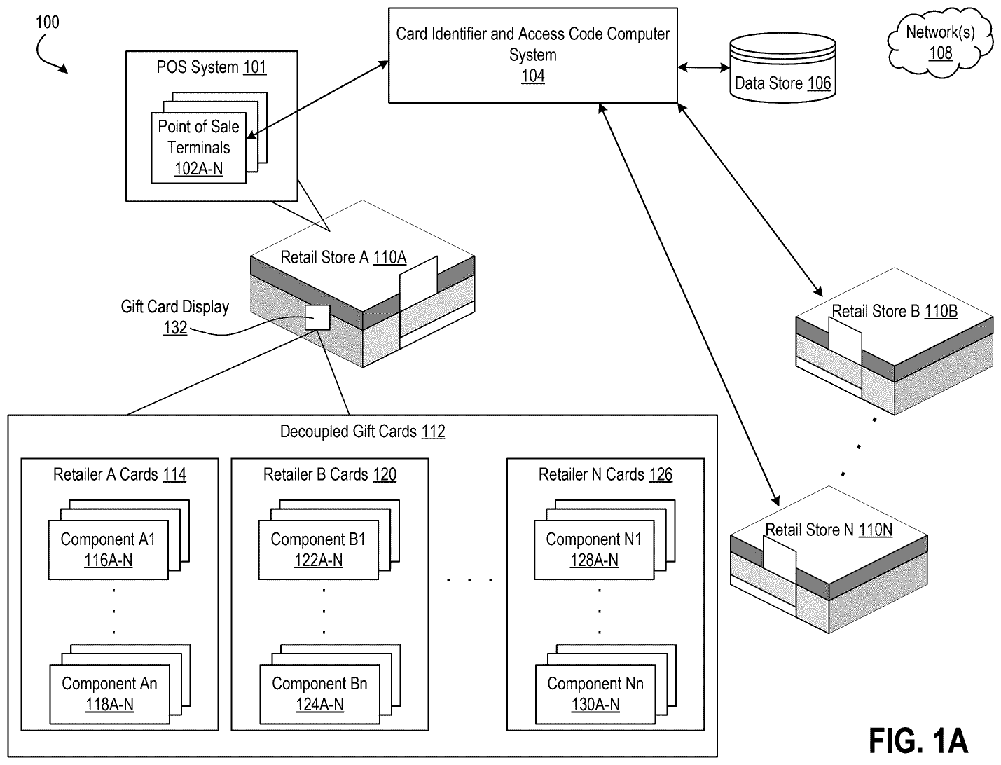

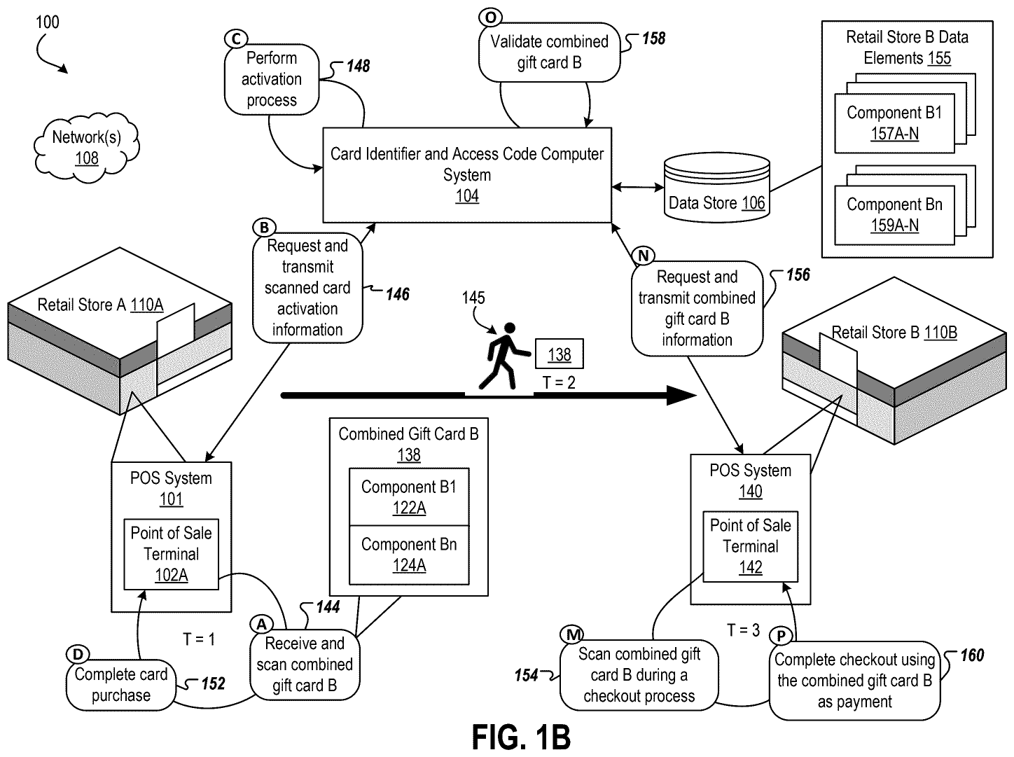

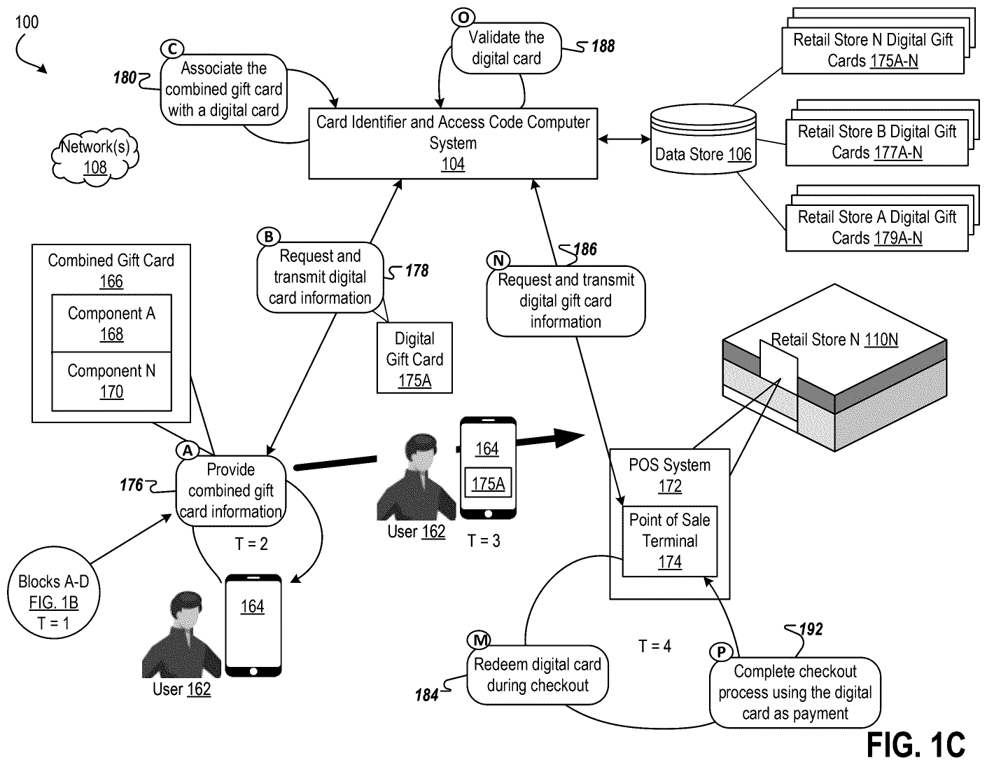

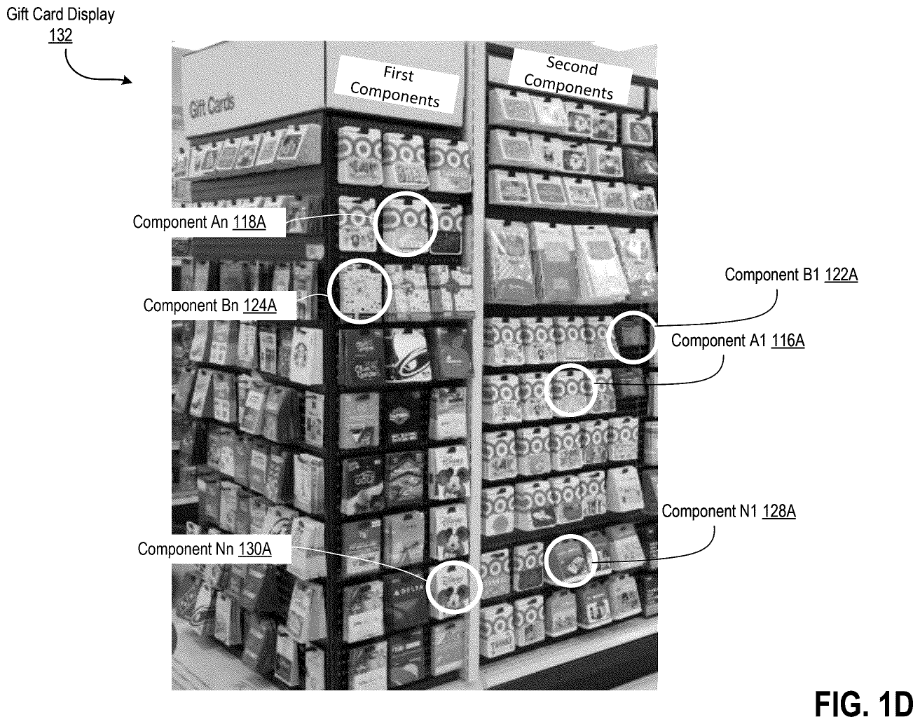

Referring to the figures, FIG. 1A is a conceptual diagram of a system 100 for activating and validating decoupled gift cards 112. The system 100 can include a plurality or group of retail stores A-N (110A-N). The stores A-N (110A-N) can be part of a same network. Sometimes, one or more of the stores A-N (110A-N) may not be part of a same network. For example, the retail store A (110A) can be a first store and the retail stores B-N (110B-N) can be third party stores that are not part of a same network, retailer, enterprise, and/or organization as the retail store A (110A). Various other combinations of the stores A-N (110A-N) are also possible.

Each of the stores A-N (110A-N) can have at least one gift card display 132. The gift card display 132, as shown in this example as being part of the store A (110A), can be configured to mount or otherwise display the decoupled gift cards 112 for selection and purchase by users or guests at the store A (110A). Refer to FIG. 1D for further discussion about the gift card display 132.

The decoupled gift cards 112 can include retailer A cards 114, retailer B cards, retailer N cards 126, etc. In this example, the retailer A cards 114 can correspond to decoupled card components that can be combined and used at the store A (110A), the retailer B cards 120 can correspond to decoupled card components that can be combined and used at the store B (110B), and the retailer N cards 126 can correspond to decoupled card components that can be combined and used at the store N (110N). The decoupled gift cards 112 on display at the store A (110A) can include any combination of decoupled gift card components that are associated with any other retail stores or combination of retail stores that may be part of the system 100.

The retailer A cards 114 can include components A1 (116A-N) through components An (118A-N). The retailer B cards 120 can include components B1 (122A-N) through components Bn (124A-N). The retailer N cards 126 can include components N1 (128A-N) through components Nn (130A-N). Each of the retailer cards can include first components (e.g., the components A1, 116A-N) and second components (e.g., the components An, 118A-N). The first and second components can be combined during a checkout process at point of sale (POS) terminals 102A-N in order to activate a decoupled gift card. In some implementations, the first component can include a gift card and the second component can include a label. Sometimes, the second component can include multiple parts or components, such as one or more labels. The second component can include, but is not limited to, an envelope, sleeve, wrapper, film, insert, or other type of material that can be combined with the first component to create the decoupled gift card during the checkout process. Although the decoupled gift cards 112 of the system 100 in FIG. 1A are shown and described as including two components per retailer, one or more additional components can also be provided and used for one or more of the retailers to create the decoupled gift card during the checkout process. As a merely illustrative example, a retail store Z may require three card components to be combined together during the checkout process—a card, an envelope, and a label. These three components can be mounted to and provided by the gift card display 132 in the retail store A (110A) so that a guest shopping in the store A (110A) can select the three components, bring them to one of the POS terminals 102A-N, combine the components, and purchase the resulting decoupled gift card.

In some implementations, one or more components for the decoupled gift cards 112 may be presented at the gift card display 132 and one or more other components for the decoupled gift cards 112 may only be available at checkout. As an illustrative example, the component A1 (116A-N) for the retailer A cards 114 can be a physical gift card that is mounted to the gift card display in the retail store A (110A). The component An (118A-N), on the other hand, can be a physical label with an access code and other unique identifying information, which may be dispensed at the POS terminals 102A-N and/or only accessible by a team member or other employee in the retail store A (110A). Accordingly, only the team member(s) may have access to the label with the access code, which can further improve security of the decoupled gift cards 112.

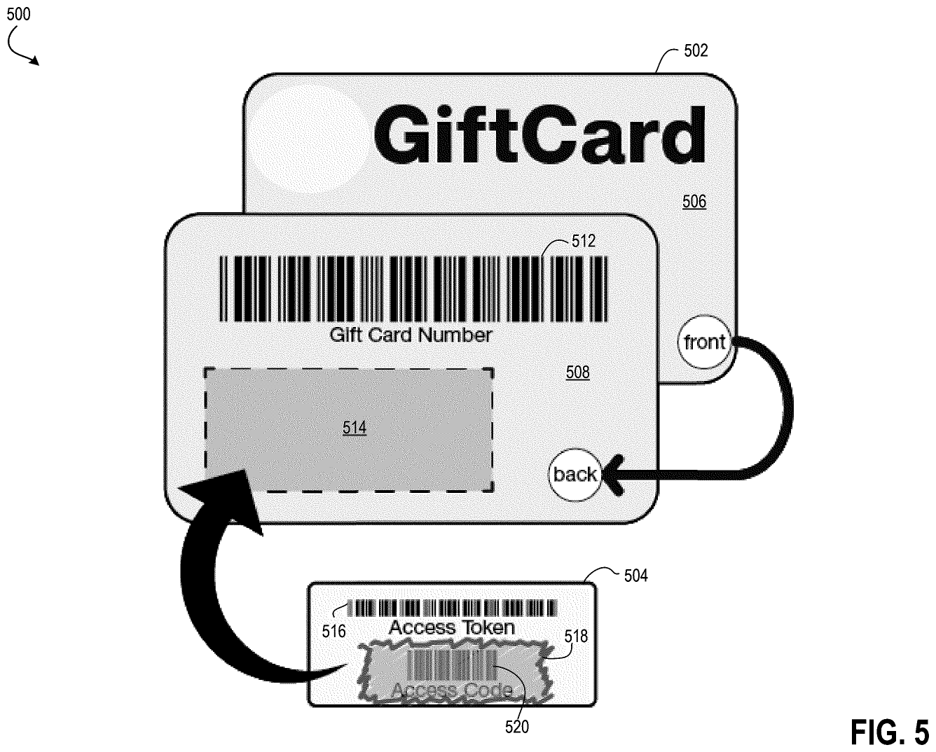

Although the components for the decoupled gift cards 112 are described as separate components for each of the different retail stores A-N (110A-N), one or more of the components can be common components across all the stores A-N (110A-N) or a combination or subset of the stores A-N (110A-N). For example the stores A-N (110A-N) can have respective first components, such as physical gift cards, but share common second components, such as labels with access codes or other unique identifying information. As another example, the stores A-N (110A-N) can have respective second components, such as labels, and share common first components, such as generic physical gift cards. Various other configurations may also be possible. Refer to FIG. 5 for an illustrative example of a decoupled gift card.

Each of the stores A-N (110A-N) can have respective POS systems 101 with respective POS terminals 102A-N. The POS terminals 102A-N can be part of belted checkout lanes and/or self-checkout lanes. The POS terminals 102A-N can be used by guests and team members in the retail store A (110A) to complete checkout processes for purchasing items, including but not limited to any of the decoupled gift cards 112. The POS terminals 102A-N of the POS system 101 can be configured to communicate (e.g., wired, wirelessly) via network(s) 108 with a card identifier and access code computer system 104 (“computer system 104”).

The card identifier and access code computer system 104, as described further herein, can be configured to perform techniques and processes for activating and/or validating decoupled gift cards that are purchased in the stores A-N (110A-N). The computer system 104 can also be used to validate, authorize, and/or redeem the decoupled gift cards, once purchased, for use in any of the stores A-N (110A-N). The computer system 104 can be any type of computing system, computing device, edge device, network of computing devices/systems, and/or cloud-based system. The computer system 104 can be local to one or more of the stores A-N (110A-N). The computer system 104 can be remote from one or more of the stores A-N (110A-N0.

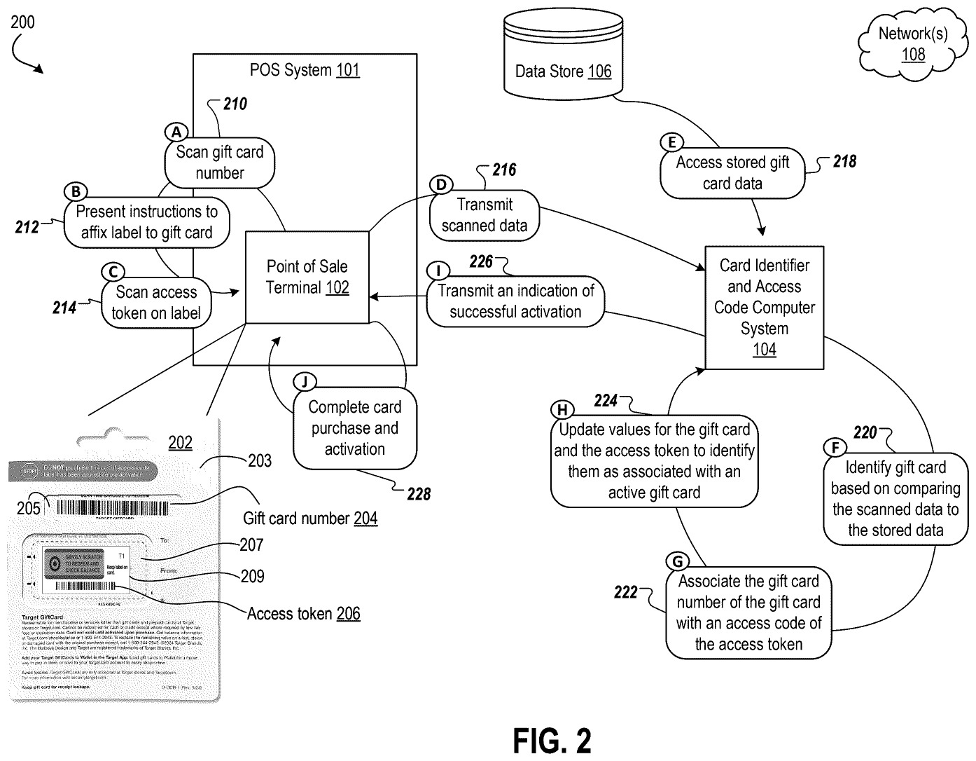

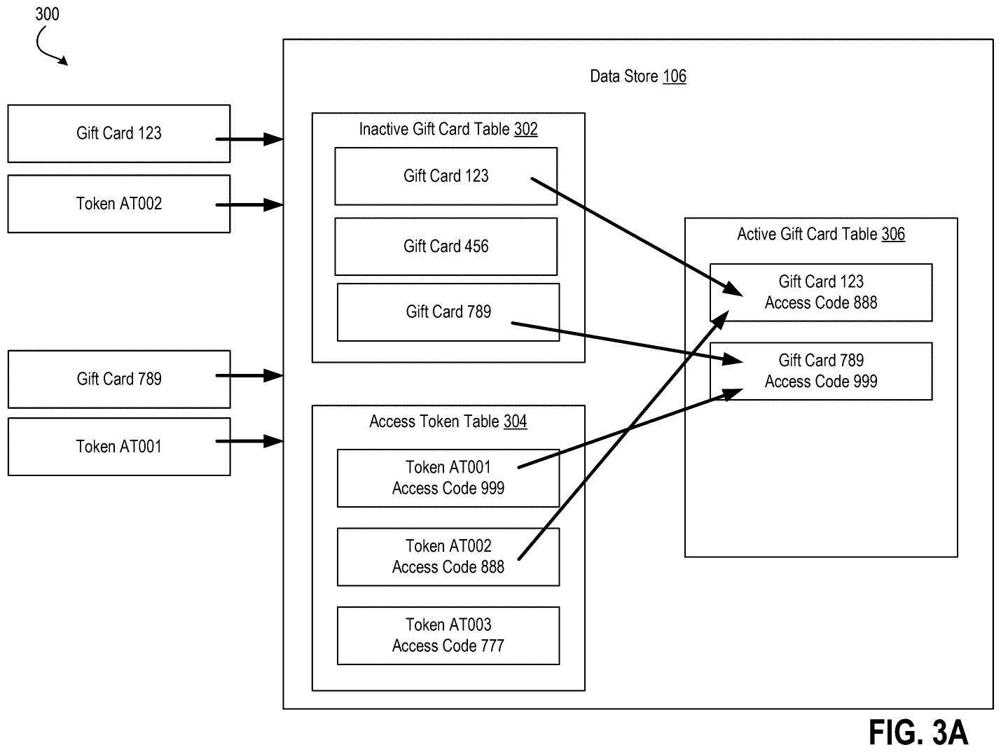

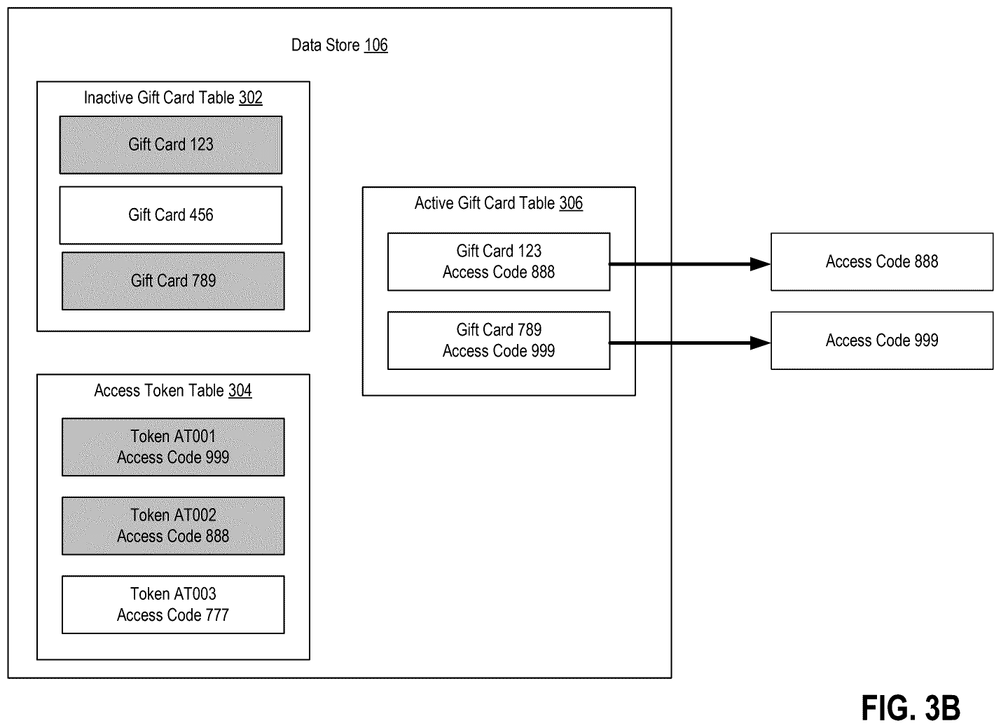

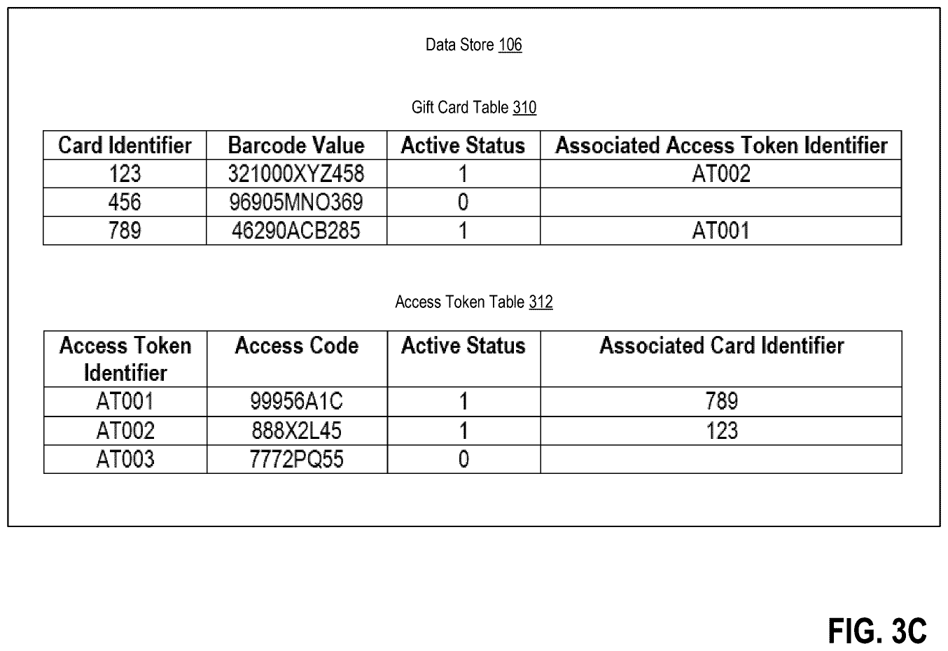

The computer system 104 may also communicate with a data store 106 to perform the activation, validation, redemption, and/or authorization processes. The data store 106 can be configured to maintain information about the decoupled gift cards 112. For example, the data store 106 can maintain and dynamically update information indicating associations between different card components for different retail stores. The data store 106 can maintain and/or dynamically update information indicating whether any of the components (e.g., gift cards) are coupled with other components and thus active or not coupled with other components and thus inactive. Refer to FIGS. 3A, 3B, and 3C for further discussion about maintaining and updating information in the data store 106 about the decoupled gift cards 112. Refer to FIGS. 1B, 1C, and 2 for further discussion about activating, validating, redeeming, and/or authorizing the decoupled gift cards 112.

Although the POS system 101 having the POS terminals 102A-N and the gift card display 132 having the decoupled gift cards 112 is shown and described in reference to the store A (110A) in FIG. 1A, such system components can also be configured and used in the other stores B-N (110B-N) in the system 100.

FIG. 1B is a conceptual diagram of the system 100 from FIG. 1A for activating a decoupled gift card 138 at a first retail environment, the retail store A (110A), and redeeming the decoupled gift card 138 at a second retail environment, the retail store B (110B).

The POS terminal 102A of the POS system 101 in the retail store A (110A) can communicate via the network(s) 108 with the card identifier and access code computer system 104 to active a gift card, such as combined (e.g., decoupled) gift card B 138. A POS terminal 142 of a POS system 140 in the retail store B (110B) can also communicate via the network(s) 108 with the computer system 104 in order to redeem or otherwise validate the combined gift card B 138 when used during a checkout process in the store B (110B). Accordingly, the computer system 104 can act as a centralized system for authenticating, authorizing, validating, and redeeming gift cards that can be used in any of the stores that are part of the system 100.

At a first time, T=1, the POS terminal 102A in the retail store A (110A) can receive and scan the combined gift card B 138 from a guest 145 (block A, 144). The combined gift card B 138 can include the component B1 122A and the component Bn 124A, described in reference to FIG. 1A. The combined gift card B 138 can be a gift card associated with the retail store B (110B). In other words, the combined gift card B 138 may only be used by the user 145 at the retail store B (110B). In some implementations, the combined gift card B 138 can be a generic gift card that can be used at one or more other stores in the system 100. Refer to FIG. 5 for further discussion about an illustrative combined gift card. In block A (144), identifying information, such as barcodes, QR codes, or other identifiers on the component B1 122A and/or the component Bn 124A of the combined gift card B 138 can be scanned using scanning devices at the POS terminal 102A.

The scanned information can be transmitted by the POS system 101 of the POS terminal 102A to the computer system 104 (block B, 146). In other words, the POS system 101 and/or the POS terminal 102A can request and transmit scanned card activation information with the computer system 104.

The computer system 104 can perform an activation process in block C (148). Refer to at least FIGS. 2, 3A, 3B, and 3C, and 4 for further discussion about the activation process. In brief, performing the activation process can include accessing retail store B data elements 155 maintained in the data store 106. These data elements can include component B1 data 157A-N and component Bn data 159A-N. The data store 106 can also store and update data elements associated with other retail stores in the system 100. By accessing the data elements 155, the computer system 104 can determine whether the component B1 122A and/or the component Bn 124A are already associated with other components (and thus part of an active gift card) or whether the components are not yet associated with others. If the components B1 122A and Bn 124A are not associated with other components, then the computer system 104 can associate them with each other and retrieve an access code corresponding to the component Bn 124A. That access code may now be associated with the component B1 122A and used by the guest 145 to redeem and use the combined gift card B 138 in future purchases at the retail store B (110B). The access code can be pre-generated and accessed at time of sale, T=1. In some implementations, access codes can be generated in real-time during the checkout process at T=1 for particular types of items (e.g., video games, electronic devices, or other predetermined item categories).

Once the computer system 104 completes the activation process in block C (148), the computer system 104 can transmit the card activation information back to the POS terminal 102A (block B, 146). The card activation information can include an indication that the combined gift card B 138 has been successfully activated. The POS terminal 102A can complete the purchase of the combined gift card B (138).

Sometime later, at T=2, the guest 145 can take the purchased combined gift card B 138 to the retail store B (110B) to be used.

At T=3, after T=1 and T=2, the guest 145 can use the combined gift card B 138 to make a purchase at the store B (110B). The POS terminal 142 of the retail store B (110B) can scan the combined gift card B 138 during a checkout process (block M, 154).

The POS system 140 associated with the POS terminal 142 can request and transmit combined gift card B 138 information to the computer system 104 (block N, 156).

The computer system 104 can validate the combined gift card B 138 in block O (158). Validating the combined gift card B 138 can include accessing the retail store B data elements 155 in the data store 106 and determining whether the component B1 122A is associated with the component Bn 124A of the combined gift card B 138. Refer to at least FIGS. 2, 3A, 3B, 3C, and 4 for further discussion about validating the combined gift card B 138.

Once the combined gift card B 138 is validated, the computer system 104 can transmit the combined gift card B 138 validation information to the POS terminal 142 of the POS system 140 (block N, 156). The validation information can include an indication that the combined gift card B 138 is valid and can be used during the checkout process at T=3 at the retail store B (110B). The validation information may additionally include an indication that the combined gift card B 138 was activated and sold by the retail store A (110A). In some implementations, the validation information can include the access code for using the combined gift card B 138.

The POS terminal 142 can then complete the checkout process using the validated, combined gift card B 138 as payment (block P, 160). For example, the POS terminal 142 can receive the access code from the computer system 104 as part of the validation information and then use that access code to apply the combined gift card B 138 as the form of payment for the checkout process.

The system 100 described in reference to FIG. 1B can be implemented in a variety of use cases. For example, the techniques described in FIG. 1B can be performed where the retail store B (110B) is a third party retailer that issues the components for the combined gift card B 138 to be sold in the retail store A (110A), which is not associated with the third party retailer. Although the components for the combined gift card B 138 are sold by a different retailer, the combined gift card B 138 is directly redeemable at the third party retailer's store B (110B). In some implementations, the computer system 104 may be associated with the retailer of the retail store A (110A) and not the third party retailer of the store B (110B). The computer system 104 can therefore make one or more API calls to a computer system of the store B (110B), or their intermediary system, to receive gift card identifying information for the components of the combined gift card B 138 (e.g., card number, access code, card value). This received information can then be stored in the data store 106 as the retail store B data elements 155. In some implementations, the computer system of the third party retailer can generate the access code for the combined gift card B 138 dynamically.

In another example use case, the combined gift card B 138 can be issued by the third party retailer of the store B (110B), the retailer associated with the store A (110A), or any other retailer in the system 100. The combined gift card B 138 can be redeemed, using the techniques described in reference to FIG. 1B, at the store A (110A), the store B (110B), or any other store in the system 100. Therefore, the POS system of any of the stores in the system 100 can be configured to communicate with the computer system 104 to activate and/or validate the combined gift card B 138. The POS systems of any of the stores in the system 100 can be retrofitted or otherwise updated to communicate via the network(s) 108 with the computer system 104, regardless of which retailer(s) each of the stores is associated with.

FIG. 1C is a conceptual diagram of the system 100 for redeeming a digital gift card 175A for use at a retail environment, such as the retail store N (110N). In brief, a user 162 can receive a physical combined gift card 166 and redeem the gift card 166 using their mobile device 164. The mobile device 164 can be any type of computing device associated with the user 162, including but not limited to a mobile phone, smartphone, wearable device, smart watch, home PC, laptop, or other personal mobile device. The user 162 can be a recipient of the gift card 166. In some implementations, the user 162 can be a guest that purchases and activates the gift card 166 at any of the retail stores in the system 100. The user 162 can provide credentials at their mobile device 164 for the combined gift card 166, such as a card number, to redeem a digital certificate (e.g., the digital gift card 175A, a digital access code for the physical combined gift card 166) corresponding to the digital gift card 175A. This digital certificate can add an extra layer of security to prevent others, such as malicious users, from potentially stealing the physical combined gift card 166 and using the stolen card. The digital gift card 175A can be maintained/accessed at the mobile device 164 and then used to make purchases at the retail store N (110N) or any other retail store that may be part of the system 100. For example, the digital gift card 175A can be maintained in and accessible from a digital wallet at the mobile device 164. As another example, the digital gift card 175A can be provided to the user 162 via email and/or text message, which can be accessed at the mobile device 164. In some implementations, the digital gift card 175A can be in the form of a credit that is applied on a retailer's website to the redeemer's profile for that website. The retail store N (110N) or other stores in the system 100 can have a computing system that communicates with the computer system 104 to validate or otherwise authorize a purchase with the digital gift card 175A made by the user 162.

At time T=1, blocks A-D (144-152) described in FIG. 1B can be performed to purchase the physical combined gift card 166. The gift card 166 can be purchased by the user 162 or another user/guest. The gift card 166 can be purchased at any retail store in the system 100. The combined gift card 166 can include a component A (168) and a component N (170). As an illustrative example, the component A (168) can be a physical gift card and the component N (170) can be a physical label. The component N (170) can be attached to the component A (168) at T=1, when the gift card 166 is purchased.

At time T=2 in FIG. 1C, the user 162 can provide information associated with the combined gift card 166 at their mobile device 164 (block A, 176). In other words, the user 162 can input information such as a card number on the component A (168) and/or an access code token on the component N (170) into a mobile application or a website/browser launched at the mobile device 164. The mobile device 164 can request and transmit digital card information with the card identifier and access code computer system 104 in block B (178).

The computer system 104 can associate the combined gift card 166 with a digital card in block C (180), based on the card information that was provided by the mobile device 164. The card number, for example, can be an access code or key to a corresponding digital gift card in the computer system 104. The access code to unlock the corresponding digital gift card may not be assembled or otherwise available until the components 168 and 170 are combined to create the combined gift card 166 during checkout at T=1 and/or the user 162 activates the combined gift card 166 at their mobile device 164 at T=2. The computer system 104 may be inaccessible to the public, and thus can ensure enhanced security of digital gift cards since a potentially malicious actor cannot simply drain the physical combined gift card 166 of its funds using only the card number printed on the combined gift card 166. In some implementations, when the physical combined gift card 166 is purchased and/or activated at T=1 and/or T=2, a digital token can be created, accessed, and verified using the computer system 104. This digital token can then be used to access the digital gift card 175A and provide the digital gift card 175A to the user 162.

Block C (180) can include accessing the data store 106 to retrieve the digital gift card 175A that corresponds to the card information provided by the mobile device 164. The digital gift card 175A can be retrieved amongst retail store N digital gift cards 175A-N, retail store B digital gift cards 177A-N, and/or retail store A digital gift cards 179A-N that are maintained by the data store 106. The digital gift cards can be preexisting and stored in the data store 106 for runtime retrieval and use. In some implementations, each retail store can generate their respective digital gift cards and provide/store the digital gift cards in the data store 106. In some implementations, one or more of the digital gift cards can be generic and therefore able to be used by and for one or more of the retail stores in the system 100. Once the digital gift card 175A is identified and/or retrieved, the corresponding digital card information can be provided to the mobile device 164 of the user 162 (block D, 178).

At time T=3, the user 162 can go to the retail store N (110) with their mobile device 164 having the digital gift card 175A. As described herein, in some illustrative examples, the digital gift card 175A can be loaded into a digital wallet on the mobile device 164 and accessed by the user 162 for use in purchases at the retail store N (110N). In some implementations, as shown in FIG. 1C, the digital gift card 175A can be redeemed for use at the retail store N (110N). Sometimes, the digital gift card 175A can be redeemed for use at other retail stores in the system 100. Sometimes, the user 162 can go to the retail store N (110) with printed information related to the combined gift card 166 instead of the digital gift card 175A that is accessible at their mobile device 164. The printed information may include a receipt from the transaction for purchasing the combined gift card 166. The printed information may include an access code or other car identifying information, which can be printed on the combined gift card 166 and/or accessible by scanning information (e.g., barcodes) on the combined gift card 166.

At time T=4, the user 162 can redeem the digital gift card 175A during checkout at a POS terminal 174 of a POS system 172 in the retail store N (110N) (block M, 184). For example, the user 162 can present the digital gift card 175A at their mobile device 164 to be scanned with scanning devices at the POS terminal 174. The user 162 can present, for example, a barcode or other unique identifier for the digital gift card 175A in the digital wallet, a mobile application launched at the mobile device 164, and/or a web/mobile browser at the mobile device 164. Redeeming the digital gift card 175A can include scanning the barcode or other unique identifier for the digital gift card 175A that is presented on the mobile device 164.

The POS terminal 174, or the POS system 172 more generally, can request and transmit the digital gift card information to the computer system 104 in block N (186). For example, the POS terminal 174 can transmit information associated with the scanned barcode or other unique identifier for the digital gift card 175A.

Using the transmitted digital gift card information, the computer system 104 can validate the digital gift card 175A (block O, 188). Validating the digital gift card 175A can include accessing the data store 106 and checking for an association between the digital gift card 175A and the combined gift card 166. If the association exists, for example, the computer system 104 can validate the digital gift card 175A so that it can be used during checkout at time T=4. If the association does not exist, for example, the computer system 104 can transmit information back to the POS terminal 174 denying the digital gift card 175A as a form of payment. the computer system 104 can retrieve and apply validation rules so ensure secure sales, such as restricting certain access tokens to certain third party retailers.

Once the digital gift card 175A is validated in block O (188), the computer system 104 can transmit digital gift card information to the POS terminal 174 (block N, 186). The transmitted information can include an indication that the digital card 175A has been successfully validated. Sometimes, the information can include a redemption code or access code for the digital gift card 175A so that funds can be removed from the digital gift card 175A during checkout at T=4.

Accordingly, the POS terminal 174 can complete the checkout process using the digital gift card 175A as payment in block P (192).

The operations and techniques described in reference to FIG. 1C can be performed in a variety of use cases. For example, the combined gift card 166 components A (168) and N (170) can be sold at a retail store that may not be associated with the retail store N (110N). The physical combined gift card 166 may not be directly redeemable at the retail store N (110N), which enables the user 162 to convert the physical combined gift card 166 to the digital gift card 175A to be used at the retail store N (110N). The user 162 can provide identifying information on the components of the combined gift card 166 to a mobile application or web application in order to redeem a card number and access code for the digital gift card 175A. The card number and the access code for the digital gift card 175A can be generated by the third party retailer associated with the retail store N (110N). In some implementations, the computer system 104 can make a call (using APIs) and/or request the third party card number and access code directly from a computing system of the retail store N (110N), instead of accessing the information stored in the data store 106. Once the digital gift card 175A is determined and/or retrieved, it can be provided to the user 162 via email, to a digital wallet as described above, in a text message, in a push notification, or other form of communication. As another example use case, the operations and techniques described in FIG. 1C can be used to redeem a digital gift card that can be used at the retail store N (110N) or at other retail stores in the system 100 that may or may not be associated with the retail store N (110N).

FIG. 1D illustrates the example gift card display 132 in a retail environment, such as any of the retail stores described herein. The display 132 can include a physical apparatus for mounting and retaining gift card components, which can be viewed and selected by guests in the retail environment. The display 132 can retain first and second gift card components, which can be combined and purchased for redemption with different retailers. The first components can include physical gift cards. The second components can include labels, envelopes, sleeves, wrappers, and/or films that can be applied to or otherwise affixed to the first components. For example, the display 132 can retain at least the component A1 116A, B1 122A, N1 128A, An 118A, Bn 124A, and Nn 130A described in reference to at least FIG. 1A. As shown in FIG. 1D, the components for various different retailers can be presented on the same display 132 in the retrial environment. Sometimes, multiple displays 132 can be used in the retail environment for presenting the components associated with the different retailers. Sometimes, the display 132 may only present the first components (e.g., the components A1 116A, B1 122A, and/or 128A). The second components can be provided or dispensed from a dispenser mechanism that is maintained in a checkout area of the retail environment (or carried, worn, or used by team members in the retail environment).

FIG. 2 is a conceptual diagram of a system 200 for activating a decoupled gift card 202 during a checkout process.

The decoupled gift card 202 can include an envelope 203 with a physical gift card 205 sealed inside the envelope 203. The gift card 205 can include a gift card number 204, such as a barcode, QR code, or other unique identifier, that can be visible through a first opening in the envelope 203. The envelope 203 can include a second opening through which a designated area 207 of the gift card 205 can be visible. A label 209 can be attached or affixed to the designated area 207 and thus visible through the second opening of the envelope 203. The label 209 can include an access token 206, such as a barcode, QR code, or other unique identifier. The access token 206, like the gift card number 204, can be scanned during a checkout process to activate the decoupled gift card 202. The decoupled gift card 202 of FIG. 2 is merely an illustrative example. Other examples of a decoupled gift card may include a card combined with an envelope, sleeve, film, insert, and/or multiple labels. Sometimes, the decoupled gift card can include sub-components of a physical gift card. Other combinations of components are also possible for the decoupled gift card.

In the system 200, the gift card number 204 can be scanned (e.g., using scanning devices) at the POS terminal 102 of the POS system 101 in block A (210). When this checkout process begins, decoupled gift card 202 can be presented at the POS terminal 102 with only the gift card 205 therein. In other words, the label 209 may not yet be affixed to the gift card 205 and instead can be coupled to the gift card 205 as part of the checkout process.

The POS terminal 102 can present instructions to affix the label 209 to the designated area 207 of the gift card 205 in response to the scanning (block B, 212). For example, based on scanning the card number 204, the POS terminal 102 can determine that a gift card purchase is being made. Thus, the POS terminal 102 can present, in a graphical display, instructions for retrieving the label 209 and attaching the label 209 to the designated area 207 of the gift card 205 in the decoupled gift card 202. The label 209 can be provided to a guest at a self-checkout lane by a team member. The team member can attach the label 209 to the gift card 205. As another example, the label 209 can be dispensed from a dispenser or other apparatus and provided to the guest at the self-checkout lane or a team member at a belted checkout lane.

Once the label 209 is affixed to the gift card 205, the POS terminal 102 can scan the access token 206 printed on the label 209 (block C, 214). The access token 206 can be a token used by the card identifier and access code computer system 104 described herein to retrieve an access code for activating, validating, and/or redeeming the decoupled gift card 202.

The scanned data can be transmitted from the POS terminal 102 to the computer system 104 in block D (126).

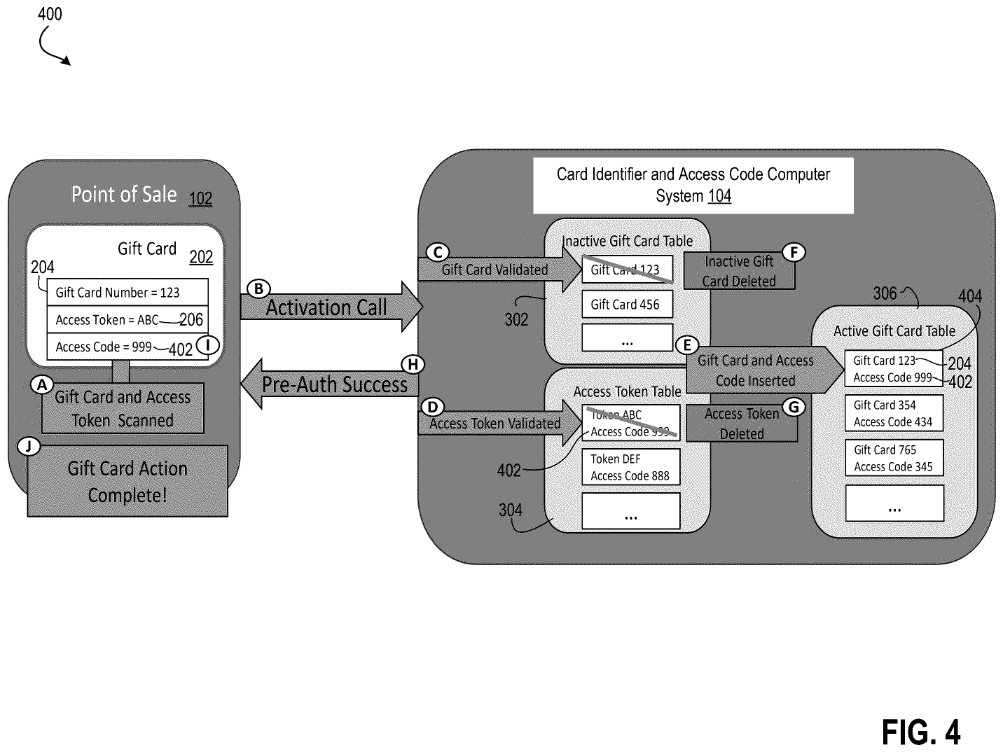

The computer system 104 can access stored gift card data from the data store 106 in block E (218). The stored data can include tables indicating inactive gift cards, access codes, and/or active gift cards. Refer to FIGS. 3A, 3B, 3C, and 4 for further discussion.

The computer system 104 can identify a gift card based on comparing the scanned data to the stored gift card data from the data store (block F, 220). For example, the computer system 104 can search one or more data tables to determine whether the gift card number 204 or the access token 206 has already been associated with other components and thus is considered to be part of an active gift card. If the values 204 and 206 are not associated with other components, then the computer system 104 can establish an association between the gift card 203 and the label 209, which identifies the decoupled gift card 202. Refer to FIGS. 3A, 3B, 3C, and 4 for further discussion.

Accordingly, the computer system 104 can associate the gift card number 204 of the gift card 203 with an access code of the access token 206 of the label 209 (block G, 222). This association can be made in an active gift card table stored in the data store 106. This association can be made by updating active/inactive values for each of the gift card 203 and the label 209 in the data store 106. Refer to FIGS. 3A, 3B, 3C, and 4 for further discussion.

In block H (224), the computer system 104 can update values for the gift card 205 and the access token 206 in the data store 106 to identify these component as associated with an active gift card. Refer to FIGS. 3A, 3B, 3C, and 4 for further discussion.

The computer system 104 can then transmit an indication of successful activation of the decoupled gift card 202 to the POS terminal 102 (block I, 226). In some implementations, the indication can include the access code, which, as described herein, can be linked to the access token 206 and retrieved based on making a successful association between the gift card 205 and the access token 206. Refer to FIGS. 3A, 3B, 3C, and 4 for further discussion.

Accordingly, the POS terminal 102 can complete purchase and activation of the decoupled gift card 202 (block J, 228).

FIGS. 3A, 3B, and 3C illustrate example techniques for associating information of decoupled gift card components with each other to activate the decoupled gift card.

In example 300 of FIG. 3A, a gift card number 123 can be scanned along with a label token AT002 in a first transaction or checkout process. The label token AT002 can be scanned in response to affixing the corresponding label to a gift card having the gift card number 123. Refer to at least FIG. 2 for further discussion. In a second transaction or checkout process, a gift card number 789 can be scanned along with a label token AT001 for a corresponding label that has been affixed to a gift card having the gift card number 789. The first and second transactions can be independent of each other and performed at different times. Both transactions are shown in FIG. 3A as a merely illustrative example. The access token values on the labels can have a format that is different than the gift card numbers. For example, every access token value can start with “AT” followed by a random string of numbers. The access token values can be used to activate a gift card, such as the gift card 123 or the gift card 789 when that gift card is purchased in a retail environment. The labels, depicted and described in reference to at least FIGS. 2, 5 and 8A, can include access codes printed thereon (e.g., 8 digit access codes), which can be hidden from view by a scratch-off material. The respective access codes of the labels can also be stored in association with the labels in the data store 106, for example in an access token table 304. An access code can therefore be retrieved from the access token table 304 when both a gift card number on a gift card and an access token on a label are scanned during a checkout process. The retrieved access code can be used to associate the label with the gift card and activate the gift card for use. The retrieved access code can be used as the access code for redeeming the gift card.

As shown in FIG. 3A, the data store 106 can maintain an inactive gift card table 302, the access token table 304, and an active gift card table 306. The inactive gift card table 302 can be configured to maintain data entries (e.g., attribute information) about each gift card component that can be sold in one or more retail stores described throughout this disclosure. In the illustrative example 300, the inactive gift card table 302 maintains gift card numbers for 3 example gift cards. The table 302 can maintain additional information for many other gift cards that may be sold and available for purchase in the one or more retail stores.

The access token table 304 can include data entries about each label component that can be sold in the retail stores and affixed to the gift card components at time of purchase. In the illustrative example 300, the table 304 can maintain information such as access token values and access codes corresponding to each of the access token values. The access token values can be globally unique references to the corresponding access codes. In some implementations, the access token values and/or the corresponding access codes can be made up of combinations of letters and/or numbers.

The active gift card table 306 can be configured to maintain information indicating associations between the gift card components and the labels that are scanned during the same checkout process. For example, the table 306 can include pairings of gift card numbers and access codes. The information that is maintained and updated in the table 306 can be accessed by other computer systems (e.g., third party retailer computing systems, POS systems in one or more different retail stores) when a user desires to redeem their decoupled gift card. The computer system can access the table 306 in the data store 106 and determine whether a scanned gift card number and/or access code correspond to each other in the table 306. If the values correspond to each other, then the decoupled gift card can be validated and redeemed.

In the example 300 of FIG. 3A, once the gift card number 123 and the access token value AT002 are scanned/received, a computer system as described herein can identify a data entry associated with the gift card number 123 in the inactive gift card table 302 and a data entry associated with the access token value AT002 in the access token table 304. The computer system can then marry the two data entries in the active gift card table 306. The computer system can designate or otherwise generate a new data entry in the table 306 that includes or otherwise pairs the gift card number 123 with the access code 888 that corresponds to the access token value AT002 in the access token table 304.

Similarly, when the gift card number 789 and the access token value AT001 are scanned/received, the computer system can identify the data entry corresponding to the gift card number 789 in the inactive gift card table 302 and the data entry corresponding to the access token value AT001 in the access token table 304. The computer system can then designate or generate a new data entry in the active gift card table 306 that includes or otherwise pairs the gift card number 789 with the access code 999 that corresponds to the access token value AT001 in the access token table 304.

Once the pairings are made in the active gift card table 306, the inactive gift card table 302 and the access token table 304 can each be updated to reflect that the corresponding gift card and label with the access token value is no longer available to be paired with other components. Refer to FIG. 3B for further discussion about updating the tables 302 and 304 when an association or pairing is made during the purchase of a decoupled gift card.

As shown by FIG. 3B, once the card and label pairings are made in the active gift card table 306, the data entries associated with the gift card number 123 and the gift card number 789 can be updated to reflect that these gift card numbers are no longer available in the inactive gift card table 302. Similarly, the data entries associated with the access token value AT001 and the access token value AT002 can be updated to reflect that these access tokens have been paired with gift cards and therefore are no longer available for pairing. In some implementations, updating the data entries in the tables 302 and 304 can include adjusting or changing a binary value that indicates whether the corresponding gift card number or access token value is active or inactive. Refer to FIG. 3C for further discussion.

In response to pairing the gift card numbers and access token values in the active gift card table 306, the corresponding access code for each pairing can be returned. In other words, for each checkout process, the corresponding access code can be returned to complete the respective checkout process.

In FIG. 3C, the data store 106 can maintain a gift card table 310 and an access token table 312 instead of or in addition to the tables described in reference to FIGS. 3A and 3B. The tables 310 and 312 can maintain attributes about each of the gift cards and labels having access token values that are sold in the one or more retail stores described herein.

For example, the table 310 can include data entries for each gift card that include a card identifier (e.g., gift card number), barcode value, active status, and/or associated access token identifier. One or more other data entries can also be maintained and updated in the table 310. A scanned barcode on a gift card during a checkout process can be used as a pointer to the corresponding data entries for the gift card. The scanned barcode can correspond to the gift card identifier (e.g., gift card number). The active status data entry can be a Boolean value or a binary value indicating whether or not each gift card in the table 310 has been activated or is still inactive. The associated access token identifier can indicate, if each gift card has been associated with a label, the access token value for that label. In some implementations, the table 310 may not include the data entry corresponding to the associated access token identifier.

The table 312 can include data entries for each label that include the corresponding access token identifier, access code, active status, and/or associated card identifier. As described in reference to FIGS. 3A and 3B, an access token value can be scanned on each label and used as a pointer to the corresponding access token identifier in the table 312. The active status data entry can be a Boolean value or a binary value indicating whether or not each label in the table 312 has been paired with a gift card or not. The associated card identifier can indicate, if each gift card has been associated with a gift card, a card identifier corresponding to the associated gift card.

In the illustrative example of FIG. 3C, the gift card having a gift card identifier (e.g., gift card number) 123 has an active status value of 1 in the table 310, which indicates that this gift card has been paired with a label in a retail store. The table 310 further includes an entry indicating that the label associated with the gift card has an access token identifier of AT002. The gift card having a gift card identifier 456 has an active status value of 0 in the table 310, which indicates that this gift card has not been paired with a label yet in a retail store. In other words, this gift card is currently inactive and can be selected for purchase and activation by a guest in the retail store. As a result, the table 310 does not include an entry for an access token identifier of an associated label because the gift card has not yet been paired with a label. The gift card having a gift card identifier 789 has an active status value of 1 in the table 310, which indicates that this gift card has been paired with a label in a retail store and thus is active. The table 320 further indicates an entry indicating that the label associated with this gift card has an access token identifier of AT001.

Similarly, the table 312 reflects the associations between labels and gift cards that are described above. For example, the label having the access token identifier AT001 is shown in the table 312 as having an active status value of 1, which indicates that this label has been paired with a gift card. The table 312 further indicates that this label has been paired with the gift card having the card identifier 789. The label having the access token identifier AT002 is also shown in the table 312 as having an active status value of 1, which indicates that this label has been paired with a gift card. The table 312 indicates that this label has been paired with the gift card having the card identifier 123. A label having an access token identifier AT003 is shown in the table 312 as having an active status value of 0, which indicates that this label has not been paired with any gift card in the retail store(s). As a result, the table 312 does not include a data entry indicating an associated card identifier for this label.

The tables 310 and 312 in FIG. 3C are merely illustrative examples and are meant to be non-limiting examples. Various other data matrices and/or data storage systems can be used to keep track of gift cards and labels in retail stores and whether any such components are associated/paired with other components in the retail stores (and thus part of active, decoupled gift cards).

FIG. 4 is a block diagram of a process 400 for activating a decoupled gift card. The process 400 can be performed using one or more computing systems, such as POS terminals in a retail store and the card identifier and access code computer system 104. For illustrative purposes the process 400 is described from the perspective of the POS terminal 102 in a retail store communicating with the computer system 104. The process 400 can be performed during a gift card purchase and checkout process in any of the retail stores described herein.

Referring to the process 400, a gift card number 204 and an access token 206 can be scanned (using scanning devices) at the POS terminal 102 (block A). The gift card number 204 can be printed on a gift card 202. The access token 206 can be printed on a label or other component that is affixed to the gift card 202 at time of checkout.

The POS terminal 102 can make a gift card activation call (using APIs, for example) to the computer system 102 in block B. The activation call can include the gift card number 204 and/or the access token 206 that were scanned in block A.

The computer system 104 can access an inactive gift card table 302 to validate the gift card 202 (block C). For example, the computer system 104 can check the table 302 to determine whether the scanned gift card number 204 is entered into the table 302. If the scanned gift card number 204 is entered into the table 302, has an indication of being inactive, or otherwise does not have an indication of the gift card 202 being active, the computer system 104 can validate the gift card 202.

Similarly, the computer system 104 can access an access token table 304 to validate the label associated with the scanned access token 206 (block D). For example, the computer system 104 can check the table 304 to determine whether the scanned access token 206 is entered into the table 304. If the scanned access token 206 is entered into the table 304, has an indication of being inactive/unpaired, or otherwise does not have an indication of the corresponding label being active or paired with a gift card, then the computer system 104 can validate the label having the scanned access token 206.

Once the gift card 202 and the label have been validated in blocks C and D, the computer system 104 can insert, in a new data entry in an active gift card table 306, the scanned gift card number 204 and an access code 402 associated with the access token 206 from the access token table 304 (block E). The table 306 can include data entries for card-label pairings, each of those pairings indicating an active, decoupled gift card that has been purchased and activated at a retail store described herein. In this illustrative example, the table 306 includes three data entries, a data entry 404 for a gift card having the gift card number 204 (“123”), another gift card having a gift card number of 354, and at least another gift card having a gift card number of 765. The gift card having the gift card number 204 has been successfully paired with the access code 402 (“999”) of the label corresponding to the scanned access token 206.

The computer system 104 can remove the gift card having the gift card number 204 from the inactive gift card table 302 (block F). Block F can be performed in response to the computer system 104 successfully creating the data entry 404 in the table 306 in block E. In some implementations, the computer system 104 can delete an entry in the table 302 corresponding to the gift card number 204. Sometimes, the computer system 104 can update a Boolean value for the gift card number 204 in the table 302 from an inactive status to an active status. One or more other types of indicators can be used to illustrate in the table 302 and/or 306 that the gift card associated with the gift card number 204 is no longer inactive and therefore is active and paired to a label or other gift card components described herein.

The computer system 104 can remove the label having the access token value 206 from the access token table 304 (block G). Block G can be performed in response to the computer system 104 successfully creating the data entry 404 in the table 306 in block E. Block G can be performed at the same time as performing block F. Sometimes, block G can be performed before performing block F. In some implementations, the computer system 104 can delete an entry in the table 304 corresponding to the access token value 206. Sometimes, the computer system 104 can update a Boolean value for the label corresponding to the access token value 206 in the table 304 from an inactive/unpaired status to an active/paired status. One or more other types of indicators can be used to illustrate in the table 304 and/or 306 that the label associated with the access token value 206 is no longer inactive or unpaired and therefore is active and paired to a gift card or another gift card components described herein.

Once the tables 302 and 304 are updated in blocks F and G, respectively, the computer system 104 can transmit or push a pre-authorization success notification to the POS terminal 102 (block H). The notification can indicate that the gift card corresponding to the gift card number 204 has been successfully paired and activated with the label corresponding to the access token value 206. The notification can be transmitted to the POS terminal 102 with information in block H. For example, the notification can be transmitted with information such as the access code value 402.

The POS terminal 102 can receive the access code value 402 in block I. As a result of receiving the access code value 402 with the pre-authorization success notification, the POS terminal 102 can validate and complete purchase of the gift card 202 (block J).

FIG. 5 illustrates an example decoupled gift card 500. The decoupled gift card 500 can include a gift card component 502 (e.g., a first component) and a label component 504 (e.g., a second component). The gift card component 502 can include a front surface 506 and a back surface 508. The back surface 508 of the gift card component 502 can include information including but not limited to a card identifier 512 and a designated area 514. The card identifier 512 can be any type of barcode, QR code, or other unique identifier. In some implementations, the card identifier 512, once scanned during a checkout process, can be a gift card number. Sometimes, the card identifier 512, once scanned during a checkout process, can be a pointer to the gift card number or another unique value that identifies the gift card component 502. The designated area 514 on the back surface 508 of the gift card component 502 can be generally sized and shaped to receive the label component 504. The designated area 514 can include graphical elements, shading, a dotted line, or other visual indicia to indicate to a user (e.g., guest, team member or employee) where to place, affix, or otherwise couple the label component 504 to/with the gift card component 502.

The label component 504 can include information such as a label identifier 516 and an access code 520. The label identifier 516 can be a barcode, QR code, or other unique identifier. The label identifier 516 can, once scanned, be an access token value (refer to FIG. 4) for the label 504. Sometimes, the label identifier 516 can, once scanned, be a pointer to the access token value. The access token value can be linked to, associated with, or otherwise correspond to the access code 520. As described herein, the label identifier 516 can be scanned such that the corresponding access token value can be used to retrieve the access code 520 (which is not visible on the label component 504 when (i) the label component 504 is not yet paired with/attached to a gift card component or (ii) the label component 504 is attached to the gift card component 502 during the card purchase process). The access code 520 can be covered by a protective film material 518. The material 518 can be a scratch-off material. For example, the material 518 can cover the access code 520 to protect the access code 520 from being identifier or otherwise recorded by a malicious actor. Once the decoupled gift card 500 is purchased, a user, such as a recipient of the gift card 500, can remove the material 518 by scratching away the material 518 (e.g., with a coin, key, pen, or metal material). Once the material 518 is removed, the user can view the access code 520 and use the access code 520 to redeem their gift card 500 and use the gift card 500 to make purchases.

As described herein, to purchase the decoupled gift card 500, a guest in a retail store can bring the gift card component 502 to a POS terminal in a checkout area of the store. The identifier 512 can be scanned at the POS terminal using scanning devices. In response to the scanning, the guest can be prompted to apply a label, such as the label component 504 to the gift card component 502 to overlay the designated area 514 on the back surface 508 of the gift card component 502. Once the label component 504 is affixed to the designated area 514 (by the guest or a team member or employee in the checkout area), the label identifier 516 can be scanned. The POS terminal can then communicate with a remote computing system described herein (e.g., a third party system, a computer system, a broker system) to associate the gift card component 502 with the label component 504 in a data storage system. Once the association/pairing is completed by the remote computing system, the POS terminal can receive an indication that the decoupled gift card 500 has been authenticated and that the decoupled gift card 500 purchase process can be completed. Refer to at least FIGS. 1A, 1B, 1C, 2, 3A, 3B, 3C, and 4 for further discussion about purchasing the decoupled gift card 500.

Advantageously, the disclosed techniques allow for separating the gift card number corresponding to the card identifier 512 and the access code 520 corresponding to the label identifier 516 to eliminate opportunities for potentially malicious actors from coming into possession of both pieces of information needed to redeem the decoupled gift card 500. The disclosed techniques leverage a one-time access token value by scanning the label identifier 516. Since the access code 520 is hidden by the material 518, assignment of the access code 520 to the gift card component 502 of the decoupled gift card 500 is delayed until time of sale during the checkout process.

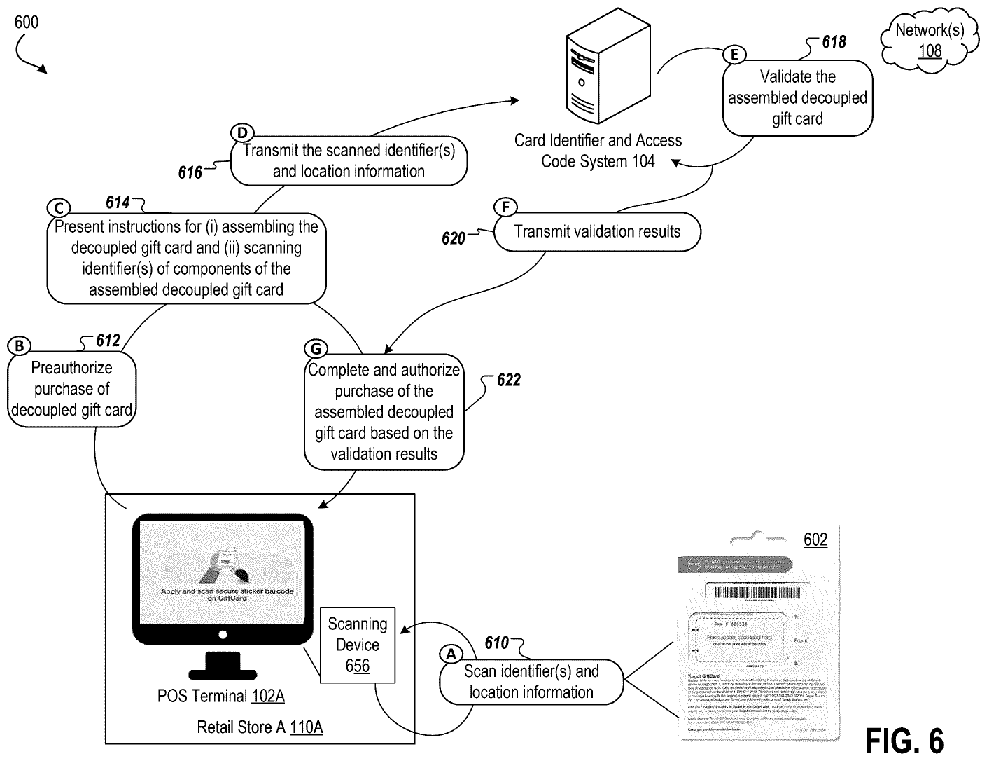

FIG. 6 is a conceptual diagram of a system 600 for purchasing a decoupled gift card 602 at a POS terminal 102A in a retail environment, such as a physical store. As described herein, the POS terminal 102A can include or otherwise be in network communication (e.g., wired, wireless) with the scanning device 656 via the network(s) 108. The POS terminal 102A can also be in communication with the card identifier and access code system 104 via the network(s) 108.

In the system 600, a guest can initiate a process to purchase the decoupled gift card 602, which can also be a third party gift card in some implementations, at the POS terminal 102A associated with the retail store A 110A. Although the process 600 is discussed herein with reference to the retail store A 110A, this is meant to be illustrative and not limiting. The process 600 to purchase the decoupled gift card 602 can take place in any of the retail stores A-N 110A-N. Refer to at least FIGS. 2 and 5 for further discussion about the decoupled gift card 602. For example, during a checkout process, the guest can use the scanning device 656 to scan one or more identifiers on the decoupled gift card 602 (block A, 610). The identifiers can include, as described herein, barcodes and/or information related to the location of the retail store 110A (e.g., retailer ID, geolocation).

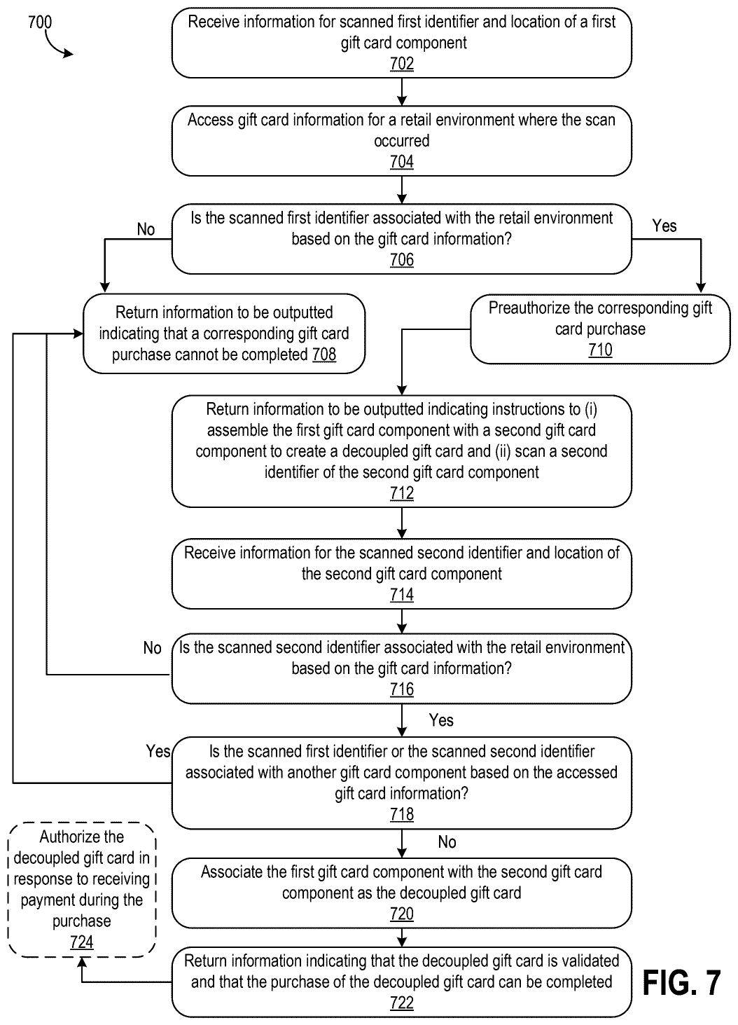

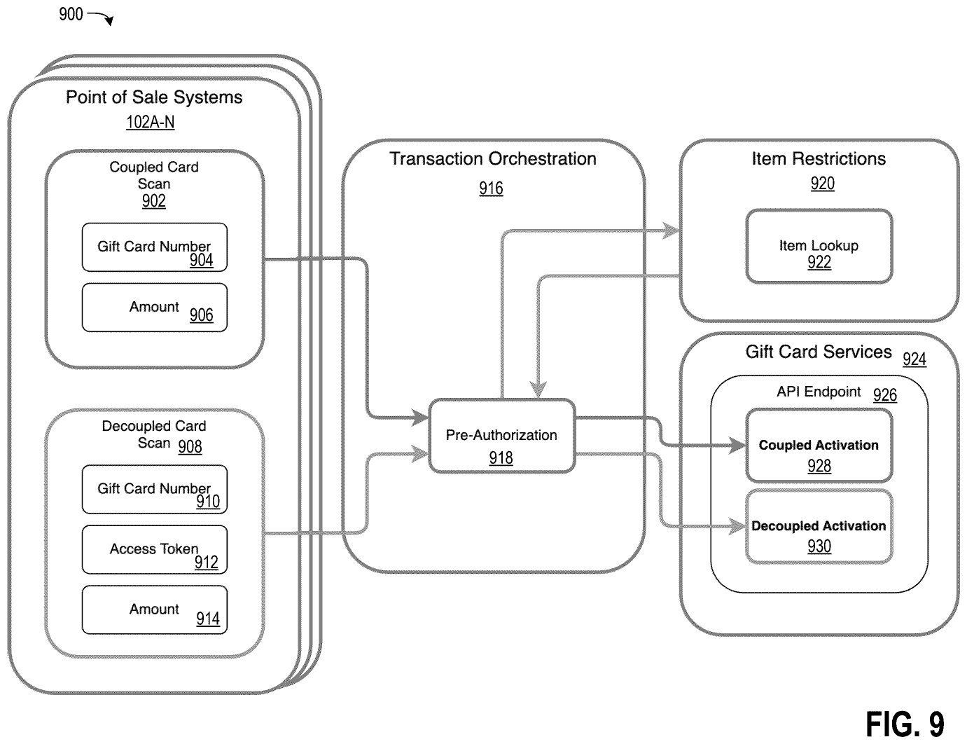

The POS terminal 102A can preauthorize purchase of the decoupled gift card 602 in response to receiving the scanned identifier(s) and location information in block B (612). Refer to FIGS. 7 and 9 for further discussion about performing the preauthorization process. For example, the preauthorization process can include checking whether the decoupled gift card 602 is associated with a store where the card 602 is being purchased (such as whether the decoupled gift card 602 is supposed to be sold at the retail store A 110A, regardless of whether or not the decoupled gift card 602 is associated with an entity or third party of that retail store). If the decoupled gift card 602 is associated with the store (e.g., the gift card 602 is intended to be purchased at the physical location of that store and not another store), then it's purchase can be preauthorized. If the decoupled gift card 602 is not associated with the store (e.g., is associated with another store or is identified as already being purchased), then the POS terminal 102A can output a prompt instructing the guest to select and scan a different decoupled gift card 602 (not depicted).

Upon completing the preauthorization purchase, the POS terminals can present instructions for (i) assembling the decoupled gift card 602 and (ii) scanning other identifiers of components of the assembled decoupled gift card 602 (block C, 614). In other words, the POS terminal 102A can output a prompt instructing the guest (or a team member at the retail environment) to apply a sticker or label to the decoupled gift card 602 and scan an identifier associated with or otherwise on the applied sticker or label. Refer to at least FIGS. 2 and 5 for further discussion about the sticker or label, applying the sticker or label to the decoupled gift card 602, and scanning the identifier(s) of the applied sticker or label.

The scanned identifiers and location information can then be transmitted to the card identifier and access code system 104 (e.g., a backend system) in block D (616). In some implementations, the identifiers can be transmitted to the system 104 as they are scanned. For example, after scanning the identifier for the decoupled gift card 602 in block A (610), the scanned identifier can be transmitted to the system 104. Sometimes, the system 104 may be configured to perform block B (612) to preauthorize purchase of the decoupled gift card 602 based on the scanned identifier. Then, once the purchase is preauthorized and the instructions are presented in block C (614), the guest can scan the identifier for the sticker or label that is applied to the card 602, which is then transmitted to the system 104 in block D (616).

In response to receiving the identifier(s), the system 104 can validate the assembled decoupled gift card 602 in block E (618), then transmit validation results back to the POS terminal 102A in block F (620). The system 104 can associate the scanned identifier values, thereby associating an access code with the assembled decoupled gift card 602. Refer to at least FIG. and 7 for further discussion about validating the assembled decoupled gift card 602.

Upon receiving the validation results, the POS terminal 102A can complete and authorize purchase of the assembled decoupled gift card 602 (block G, 622). The POS terminal 102A may present UIs that progress through a set of steps, such as requesting the guest (or the team member) to key in a desired value for the gift card 602. Once the guest provides the input and payment, the system 104 can further activate the gift card 602 with the appropriate funds amount. The UIs can include instructions and/or prompts related to team member interventions (e.g., to assist the guest, to assemble the decoupled gift card 602 with the sticker or label, to scan one or more of the identifiers, to complete purchase and loading of funds to the assembled decoupled gift card 602), purchasing multi-packs of gift cards, etc. The UIs can be adapted for presentation in mobile devices, such as the devices used by team members working in the retail environment, in some implementations. Sometimes, the UIs described herein can be presented before, during, or after any of the other blocks that are shown and described with respect to the system 600 of FIG. 6.

FIG. 7 is a flowchart of a process 700 for authorizing purchase of a decoupled gift card. The process 700 can be performed by the card identifier and access code system 104 described herein. The process 700 can also be performed by a backend computing system or server that is configured to authorize purchases of decoupled gift cards (such as a backend system of a particular retail environment or store where the card is being purchased or a cloud-based backend system that is not associated with a particular retail environment). Sometimes, one or more blocks in the process 700 can be performed by a POS terminal, such as the POS terminal where the decoupled gift card is being assembled and purchased by a guest in a retail environment. For illustrative purposes, the process 700 is described from the perspective of a backend system.

Referring to the process 700, the backend system can receive information for a scanned first identifier of a first gift card component in block 702. The first gift card component can be a gift card, as described herein. The first identifier can be a barcode or other unique identifier that is attached to or otherwise part of the gift card. The first identifier can be scanned using a scanning device at a checkout lane in the retail environment. Scanning the first identifier can initiate the process 700 for purchasing the decoupled gift card, which includes the first gift card component. Sometimes, the information for the scanned first identifier can include location information associated with the particular retail environment where the first gift card component is intended to be sold and/or purchased.

In block 704, the backend system can access gift card information for a retail environment where the scan occurred. For example, the information for the scanned first identifier can include data such as a numerical value representing the scanned first identifier, a timestamp at which the scan occurred, and/or geographic, location, or store data where the scan occurred. In block 704, the backend system can access a data store described herein using the information for the scanned first identifier.

The backend system can determine whether the scanned first identifier is associated with the retail environment, based on the gift card information (block 706). In other words, by accessing the data store, the backend system can retrieve a data mapping of gift card components to retail environments. The backend system can search the mapping to determine whether the scanned first identifier of the first gift card component is associated with the particular retail environment where the scan occurred (e.g., a location identifier for the retail environment). As another example, the backend system can determine whether the geographic, location, or store data that is received in the information for the scanned first identifier matches geographic, location, or store data that is already associated with the first identifier for the first gift card component. As a result, the backend system can determine whether the first gift card component is being purchased in a geographic location, zone, and/or particular retail environment where it is intended to be purchased, regardless of whether or not the first gift card component is a third party gift card. In some illustrative examples, as described herein, the POS terminal can determine whether the scanned first identifier is associated with the retail environment.

If the scanned first identifier is not associated with the retail environment, then the backend system can return information to be outputted indicating that a corresponding gift card purchase cannot be completed (block 708). The process 700 may then stop. If the scanned first identifier is not associated with the retail environment, the first identifier can be associated with another retail environment. Sometimes, the first identifier may no longer be associated with the retail environment because the corresponding gift card component has already been combined with another gift card component and purchased as a decoupled gift card. The information can be outputted in block 708 to indicate that the first gift card component cannot be used in the decoupled gift card purchase. Sometimes, the guest may be prompted (e.g., with prompts or other UI features presented at a display of a POS terminal) to select another gift card component and scan it's corresponding identifier to restart the decoupled gift card purchase. Sometimes, a notification or alert (e.g., message to a device of the team member, flashing light or audio sounds emitted by the POS terminal) can be transmitted to a team member in the retail environment, instructing them to assist the guest at the checkout lane. The team member can assist the guest by rescanning the first identifier, providing the guest with a new gift card component to replace the first gift card component, and/or scanning an identifier on the new gift card component to initiate and perform the decoupled gift card purchase.

If the scanned first identifier is associated with the retail environment in block 706, then the backend system can preauthorize the corresponding gift card purchase in block 710. In other words, the backend system can determine that the first gift card component is associated with the particular retail environment and is available for purchase as part of a decoupled gift card at the particular retail environment.

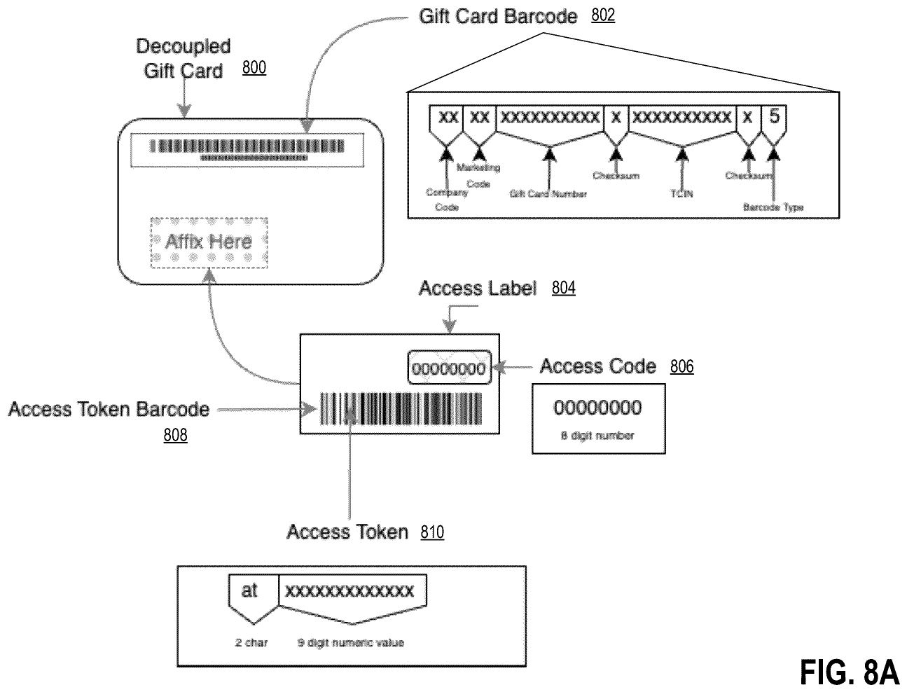

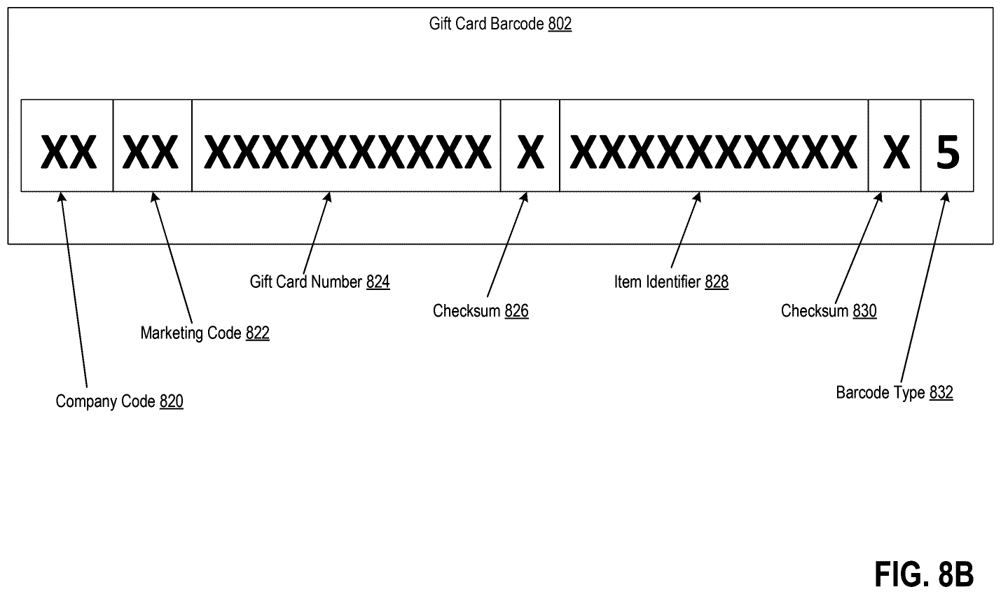

Next, the backend system can return information to be outputted indicating instructions to (i) assemble the first gift card component with a second gift card component to create a decoupled gift card, and (ii) scan a second identifier of the second gift card component (block 712). Refer to at least FIG. 8A for further information.

The backend system can receive information for the scanned second identifier of the second gift card component in block 714. The guest, or the team member, can follow the instructions presented/outputted in the display of the POS terminal to apply the second gift card component to the first gift card component. The second gift card component can include a label or sticker described herein. The second gift card component can have a second identifier affixed thereto, which the guest or team member can scan using the scanning device at the checkout lane. Data representing a numerical value of the scanned second identifier can then be transmitted (e.g., by the scanning device and/or by the POS terminal at the checkout lane) to the backend system in block 714. Sometimes, the information for the scanned second identifier can include location and/or geographic location information associated with the second gift card component, regardless of whether or not the second gift card component is a third party gift card or other third party gift card components.

The backend system can then determine whether the scanned second identifier is associated with the retail environment based on the gift card information (block 716). The backend system can perform similar operations for the scanned second identifier as described above in reference to the scanned first identifier in blocks 704 and 706. In some illustrative examples, as described herein, the POS terminal can determine whether the scanned second identifier is associated with the retail environment.

If the scanned second identifier is not associated with the retail environment, then the backend system can proceed to block 708, in which the system returns the information to be outputted indicating that the corresponding gift card purchase cannot be completed. In other words, the backend system may determine that the second gift card component is associated with a different retail environment and thus should not (and cannot) be used to purchase the decoupled gift card in the particular retail environment.

If the scanned second identifier is associated with the retail environment, then the backend system can proceed to block 718, in which the system determines whether the scanned first identifier and/or the scanned second identifier is associated with another gift card component, based on the accessed gift card information. In some implementations, blocks 706, 716, and/or 718 can be performed at the same time and/or in a different order.

If either of the scanned first identifier or the scanned second identifier is associated with another gift card component, then the backend system proceeds to block 708, described above. Thus, when such an association already exists, the components cannot be combined to purchase the decoupled gift card.

If the scanned first identifier and the scanned second identifier are not associated with other gift card components in block 718, then the backend system performs block 720, in which the backend system associates the first gift card component with the second gift card component as the decoupled gift card. For example, the backend system can temporarily pair the first and second gift card components in the data store (based on the components being associated with a geographic location or geofence of the retail environment and/or the components not being associated with other gift card components). The components can sometimes remain temporarily paired until payment is received from the guest to purchase and apply funds to the decoupled gift card. Sometimes, for example, temporarily pairing the first and second gift card components can include pulling data values associated with the components (e.g., identifiers such as barcode values) off of a ledger or other data mapping maintained by the data store so that these components cannot be used in other decoupled gift card purchases. The data values can be maintained in a temporary or intermediary holding area/data mapping in the data store until the payment and purchase operations are completed. Once the payment and purchase operations are complete, the backend system can map the gift card components to each other in another data mapping or structure of the data store described herein that is configured to maintain information about authorized and completed decoupled gift card purchases.

The backend system can then return information indicating that the decoupled gift card is validated and that the purchase of the decoupled gift card can be completed (block 722). The information can include prompts presented in the display of the POS terminal. A series of prompts can be presented at the POS terminal. For example, the prompts can include a request for the guest, or the team member, to indicate an amount of funds to be added to the decoupled gift card for purchase. Sometimes, the information can include presenting the guest's virtual shopping cart with the decoupled gift card added thereto. As another example, the information can include presenting prompts for the guest to complete purchase of items in their virtual shopping cart, which includes providing payment for the decoupled gift card

Optionally, the backend system may also authorize the decoupled gift card in response to receiving payment during the purchase (block 724). For example, once the guest provides payment to purchase the decoupled gift card, the backend system can update data entries in the data store mapping the first and second gift card components to indicate that those components are combined into the decoupled gift card. As a result of updating the data entries, the first and second gift card components may no longer be used to create other decoupled gift cards for purchase.

FIGS. 8A and 8B illustrate an example barcode 802 and access label 804 of a decoupled gift card 800. Referring to both FIGS. 8A and 8B, as described herein, the access label 804 (e.g., label, sticker) can be applied to the decoupled gift card 800 during purchase of said card 800. The decoupled gift card 800 can be considered decoupled because it is a gift card that does not have an access code associated with it. The access code becomes associated with the decoupled gift card 800 in response to performing the disclosed techniques to affix the access label 804 thereto and scan one or more components/identifiers of the access label 804. Therefore, the decoupled gift card 800 can become an active gift card upon settlement of activation techniques described herein.

The access label 804 can also include multiple components, such as an access code 806, an access token barcode 808, and an access token 810. The access label 804 is a physical label described herein, where the access code 806 can be hidden from view (e.g., via a scratch-off material) and the access token 810 can be displayed as the access token barcode 808.

The access code 806 can be an 8-digit numerical value and/or a series of characters. The access code 806 can be used, in combination with a gift card number 824 of the barcode 802, to redeem, check a balance of, and/or add the decoupled gift card 800 to a guest's wallet. The access token barcode 808 can be a visual representation or other unique identifier of the access token 810, which can be used to communicate the access token 810 to a POS terminal or other computing system described herein (e.g., the card identifier and access code system 104 or other backend systems). Therefore, the access token barcode 808 can refer to a visualization printed onto the access label 804, not the actual value it represents. The actual value is represented as the access token 810. The access token 810 can include a series of characters used as a reference to the access code 806 of the access label 804. The access token 810 can be a value that is interpreted by the POS after a scan of the access token barcode 808 and passed by the POS to the card identifier and access code system 104 or other backend system (e.g., on activation calls). The access token 810 value can be composed of a prefix, such as “at” (or another 2-character value), which can be used by the POS to identify the barcode 808 as a gift card activation token, followed by 9 numeric characters (e.g., 9-digit numeric value).

Referring to the barcode 802 of the decoupled gift card 800, The barcode 802 of the decoupled gift card 800 can have a combination of subcomponents that can be translated into numerical values once scanned by the scanning device during the checkout process. The values of the barcode 802 can be used to identify the decoupled gift card 800 and associate the card 800 with other gift card components in a data store (e.g., the label 804), as described herein.

More particularly, the barcode 802 includes an encoding of several values such as a company code 820, a marketing code 822, the gift card number 824, a checksum 826, an item identifier 828, a second checksum 830, and a barcode type 832. The barcode 802 can include additional or fewer subcomponents. The company code 820 can identify an entity that sells or otherwise offers the associated product or item (e.g., the decoupled gift card 800). The marketing code 822 can identify a class of the decoupled gift card 800, such as physical or digital, a subclass of the card 800 (e.g., sold in store, digital, business to business), and/or from where the card 800 can be activated (e.g., at a POS terminal, by an external vendor). As a result, the marketing code 822 can change based on where the associated card/component is sold and/or activated. The gift card number 824 can be a globally unique identifier for the particular decoupled gift card 800. The checksum 826 can be a value used for validating the gift card number 824, such as a Luhn Algorithm checksum. The item identifier 828 can be a reference used for retrieving more general item attributes from a centralized item definition (e.g., weight, description, restrictions). The second checksum 830 can be another value that can be used for validating the entire gift card barcode 802, such as a Luhn Algorithm checksum. The barcode type 832 can be used to distinguish between coupled and decoupled gift cards. The values encoded in the barcode 802 can be used to communicate relevant data contained in the barcode 802 to the POS terminal. References in backend reporting and/or service calls can therefore use one or more of the values that are encoded in the barcode 802 to accomplish or otherwise perform those calls.

FIG. 9 is a conceptual diagram of a system 900 for authorizing a gift card purchase during a checkout process. More particularly, the system 900 illustrates how a coupled gift card and a decoupled gift card may be processed and authorized for purchase during the checkout process. A coupled gift card may be any type of gift card that does not receive or otherwise couple with other components, such as labels or stickers described herein. A coupled gift card, for example, may not have an access token whereas the decoupled gift card has the access token. The coupled gift card can have a 26-digit gift card barcode whereas the decoupled gift card can have a 28-digit barcode. The coupled gift card can have an item identifier with a length of 9 characters where as the decoupled gift card can have an item identifier with a length of 10 characters. Moreover, the coupled gift card may not have a barcode type, whereas the decoupled gift card can have a barcode type. The barcode type can include a last digit of the barcode on the decoupled gift card. Although the system 900 is discussed herein with reference to the POS terminal 102A, this is merely illustrative and not limiting. Some or all of the components, processes, and techniques of system 900 that are described herein with reference to POS terminal 102A can associated with any of a plurality of POS terminals 102A-N.

In the system 900, the POS terminal 102A (e.g., a POS system described herein) can be configured to receive a coupled gift card scan 902 using the disclosed techniques. The scan 902 can include a gift card number 904 and an amount 906 to apply to the coupled gift card. The POS terminal 102A can transmit the coupled gift card scan 902 data (e.g., the gift card number 904 and the amount 906) to a pre-authorization module 918 of a transaction orchestration engine 916. The transaction orchestration engine 916 can be part of the card identifier and access code system 104, in some implementations. Sometimes, the engine 916 may be separate from the system 104. In some implementations, the POS terminal 102A can transmit the coupled gift card scan 902 data to one or more pre-authorization modules 918 of one or more transaction orchestration engines 916. In some implementations, the POS terminals 102A-N can transmit scan data for one or more coupled gift cards to the pre-authorization module 918 of the transaction orchestration engine 916. In yet other implementations, the POS terminals 102A-N can transmit the scan data for one or more coupled gift cards to the one or more pre-authorization modules of the one or more transaction orchestration engines. In other words, one to one, one to many, and/or many to many relationships may exist between the POS terminals 102A-N and the transaction orchestration engine(s) 916.

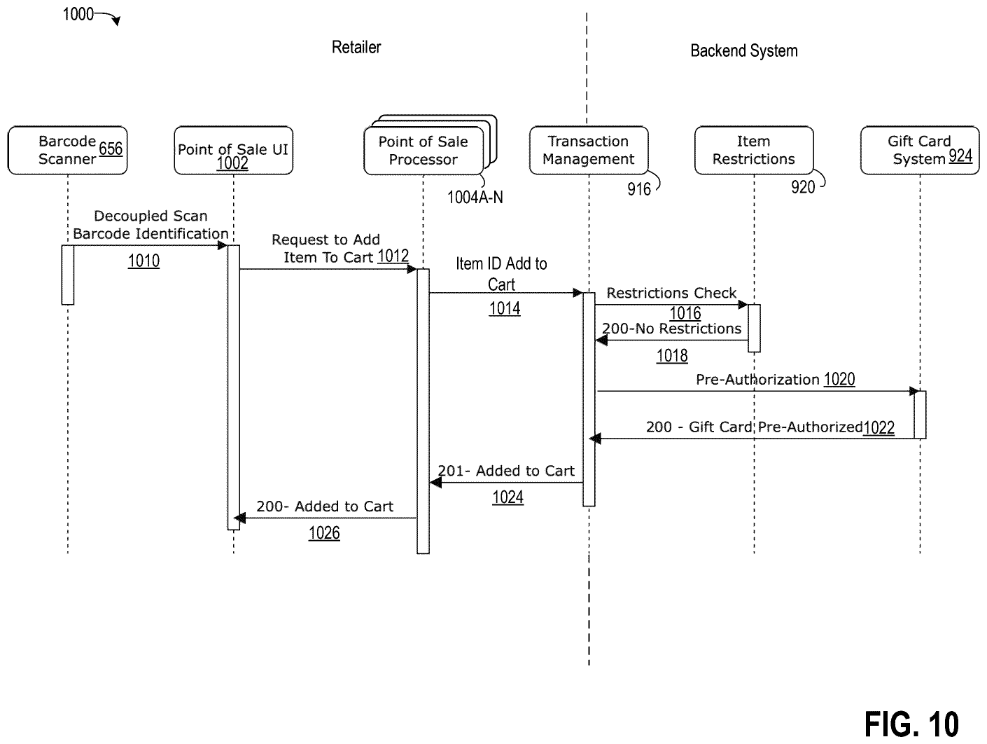

The pre-authorization module 918 can be configured to initially authorize purchase of the associated coupled gift card. For example, the module 918 can access one or more data stores and/or systems, such as an item restrictions system 920 to determine (i) whether the coupled gift card is associated with a geographic location of a retail environment where the coupled gift card is being purchased and/or (ii) whether the coupled gift card is already identified as being purchased and/or used. In other words, the module 918 can determine whether the components of the coupled gift card are associated with or inside a geofence that is established for the retail environment. An item lookup module 922 of the item restrictions system 922 can be used to perform these determinations. As another example, the module 918 can transmit a request to the gift card services system 924 to check, during pre-authorization, whether the coupled gift card is associated with a geographic location of a retail environment where the card is being purchased. Refer also to 1020 in the FIG. 10 for further discussion. As yet another example, the module 918 can transmit a request to the item restrictions system/service 920 to check for one or more item sale restrictions by leveraging an item identifier on the gift card. Refer also to 1016 in FIG. 10 for further discussion. The sales restrictions being checked can include but are not limited to: (i) validating if the gift card is above a minimum purchase amount and below a maximum purchase amount, (ii) validating if a total amount of gift cards is under a threshold transaction limit, (iii) validating if the item is a gift card item and a transaction is occupying outside store hours (e.g., with a 1 hour buffer for store end time), and/or any combination thereof.

Once the pre-authorization module 918 determines whether the coupled gift card is available for purchase, the module 918 can transmit a notification back to the POS terminal 102A, as described herein, to proceed with the checkout process. For example, payment can be received at the POS terminal 102A to complete the purchase. Upon receipt of the payment, the coupled gift card can be fully authorized and the purchase can be complete. When the coupled gift card is pre-authorized by the pre-authorization module 918 and/or when the coupled gift card purchase is completed with the payment, data stored about the coupled gift card in any of the data stores described herein and/or the item restrictions system 920 can be updated (e.g., by the system 104) to indicate that the coupled gift card is no longer available for purchase/has already been purchased. For example, the pre-authorization module 918 can access a gift card services system 924 to update coupled activation data 928 in an API endpoint 926. The coupled activation endpoint 928 can include, in a request to activate the gift card, gift card details such as the gift card barcode, the amount to add to the card, and location-specific information to identify a location where the call is being made. A response from activating the card at the API endpoint 926 can include acknowledgement of receipt, which does not include an access token for the card.

With respect to purchasing a decoupled gift card, the POS terminal 102A can receive decoupled card scan data 908, such as in response to scanning components of the decoupled gift card with the scanning device 656. The data 908 can include a gift card number 910, an access token 912 (e.g., associated with a label or sticker applied to the decoupled gift card), and/or an amount 914 to add or apply to the decoupled gift card. The data 908 can be transmitted to the pre-authorization module 918 of the transaction orchestration engine 916, which can be configured to perform similar pre-authorization checks as those performed with respect to the coupled gift card. In addition or alternatively, the pre-authorization module 918 can perform checks to determine whether any of the components of the decoupled gift card (e.g., the gift card, the label or sticker) are already associated with other gift card components and/or other gift card purchases/transactions (e.g., by accessing the item lookup module 922 of the item restrictions system 920 or other data stores and systems described herein). If none of the decoupled gift card components are already associated with other components, purchases, or transactions, the pre-authorization module 918 can pre-authorize the decoupled gift card and transmit notification back to the POS terminal 102A. The checkout process can continue, payment can be received for the decoupled gift card, and the purchase can be completed. As a result of receiving the payment and completing the purchase, the decoupled gift card can be fully authorized. The pre-authorization module 918 can also communicate with decoupled activation endpoint 930 of the API endpoint 926 to activate the decoupled gift card. The decoupled activation endpoint 930 can include, in a request to activate the gift card, gift card details such as the gift card barcode, the amount to add to the card, the access token, and location-specific information to identify a location where the call is being made. A response from activating the card at the endpoint 930 can include acknowledgement of receipt.

Although the POS terminal 102A, the transaction orchestration engine 916, the item restrictions system 920, and the gift card services system 924 are shown as separate components, this is merely an illustrative example. One or more of these components can be part of a same or similar system, such as the card identifier and access code system 104 described herein.

FIG. 10 is another conceptual diagram of a system 1000 for authorizing a gift card purchase during a checkout process. Operations described with respect to the system 1000 can be performed by components that may include the scanning device 656 (e.g., barcode scanner), a POS UI 1002, a POS processor 1004A (where the POS UI 1002 and the POS processor 1004A can be part of the POS terminal 102A described herein), the transaction orchestration engine 926 (e.g., transaction management), the item restrictions system 920, and/or the gift card services system 924 (e.g., gift card system). Although the system 1000 is discussed herein with reference to POS processor 1004A, this is merely illustrative and not limiting. Some or all of the components, processes, and techniques of system 1000 that are described herein with reference to POS processor 1004A can be associated with any of a plurality of POS processors 1004A-N. One or more other components described herein can additionally or alternatively be used to perform the operations described in FIG. 10.

In the system 1000, the barcode scanner 656 can be configured to scan a barcode of a gift card, such as a decoupled gift card, and transmit decoupled scan barcode identification information 1010 to the POS UI 1002. The POS UI 1002 can further request the POS processor 1004A to add the gift card as an item to a guest's virtual shopping cart (1012). Accordingly, the POS processor 1004A can transmit an item identifier to the transaction management engine 916 to request that the gift card be added to the guest's cart (1014). In some implementations, the POS processor 1004A can transmit the item identifier to one or more transaction management engines 916. In some implementations, the POS processors 1004A-N can transmit one or more item identifiers to the transaction management engine 916. In yet other implementations, the POS processors 1004A-N can transmit the one or more item identifiers to the one or more transaction management engines 918. In other words, and as described further above in reference to FIG. 9, one to one, one to many, and/or many to many relationships may exist between the POS processors 1004A-N and the transaction management engines 916.

The transaction management engine 916 can communicate with the item restrictions system 920 to perform a restrictions check 1016. As part of the restrictions check 1016, the engine 916 can determine whether the gift card's components are associated with a geographic location where the purchase is being made. This geographic restrictions check can be performed, in some implementations, as part of a pre-authorization 1020 of the gift card, which is described further in FIG. 9. The restrictions check 1016 can also include determining whether or not there are any sale restrictions on the gift card components, as described above in FIG. 9. In the example system 1000, the item restrictions system 920 can return an indication that there are no restrictions for purchasing the gift card (1018).

Next, the transaction management engine 916 can communicate with the gift card system 924 to perform a pre-authorization 1020 for the gift card. For example, the pre-authorization 1020 can include determining whether one or more components of the gift card have already been associated with other components, transactions, and/or purchases. If the components of the gift card have not already been associated with other components, transactions, and/or purchases (and thus are combinable with each other in the present transaction/purchase), then the gift card system 924 can return a gift card pre-authorization notification 1022 t the transaction management engine 916. In some implementations, to pre-authorize the gift card, the transaction management engine 916 and/or the item restrictions system 920 can temporarily pair the components (e.g., gift card and sticker/label) of the gift card in a data store (e.g., a table stored by the item restrictions system 920) or another intermediary holding area such that the components may not be paired with other components while the present transaction is being performed.

Since the gift card has been pre-authorized, the transaction management engine 916 can now add the gift card to the guest's virtual shopping cart 1024. The transaction management engine 916 can transmit information to the POS processor 1004A indicating that the gift card is added to the cart 1024, which can then cause the POS processor 1004A to instruct the POS UI 1002 to present the information indicating that the gift card is added to the cart 1026. As described herein, the POS UI 1002 can be automatically updated to show the gift card in the guest's virtual shopping cart. Although not shown in the system 1000 of FIG. 10, the gift card purchase can be completed by receiving payment information via the POS UI 1002, which can cause transaction completion information to be transmitted to the transaction management engine 916 by the POS processor 1004A to then cause the transaction to be completed, the gift card to be authorized and activated, and the gift card system 924 to be updated to reflect the authorization and activation of the gift card.

In some implementations, 1012 and 1014 may be performed by or otherwise associated with a retailer and/or retail environment. 1016, 1018, 1020, and/or 1022 can, in some implementations, be performed or otherwise associated with a third party, such as a third party broker and/or other backend system. Moreover, as another example, 1010, 1012, 1014, 1024, and/or 1026 can be performed or otherwise associated with the retailer and/or retail environment. The disclosed technology can also provide for relationships such as many retailers to many brokers, one retailer to one broker, many retailers to one broker, and/or one retailer to many brokers.

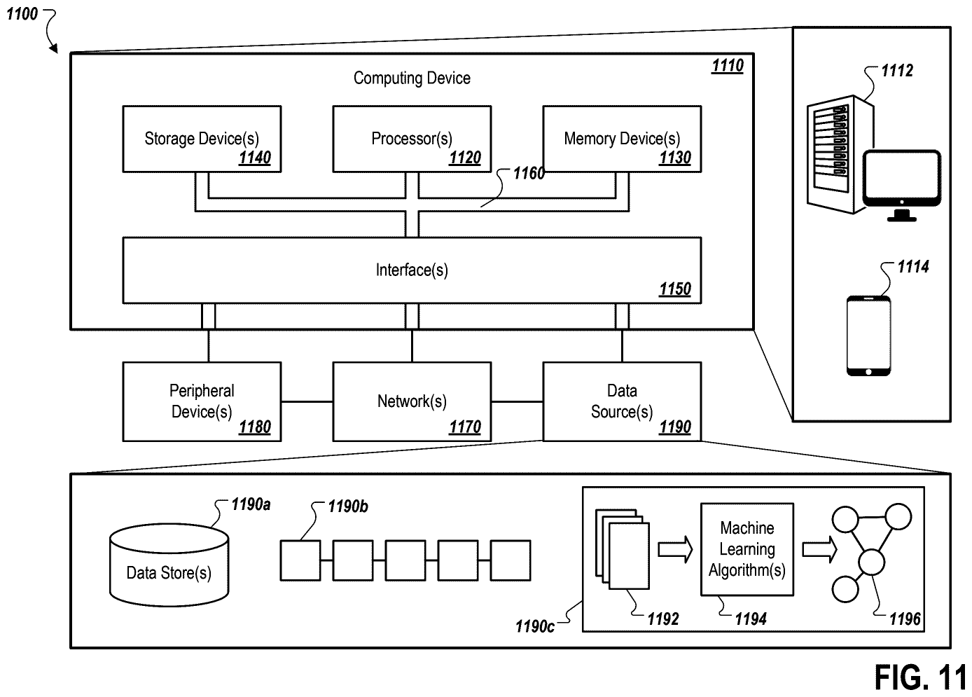

FIG. 11 is a schematic diagram that shows an example of a computing system 1100 that can be used to implement the techniques described herein. The computing system 1100 includes one or more computing devices (e.g., computing device 1110), which can be in wired and/or wireless communication with various peripheral device(s) 1180, data source(s) 1190, and/or other computing devices (e.g., over network(s) 1170). The computing device 1110 can represent various forms of stationary computers 1112 (e.g., workstations, kiosks, servers, mainframes, edge computing devices, quantum computers, etc.) and mobile computers 1114 (e.g., laptops, tablets, mobile phones, personal digital assistants, wearable devices, etc.). In some implementations, the computing device 1110 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 1110, and an entire system can be made up of multiple devices communicating with each other. For example, the computing device 1110 can be part of a computing system that includes a network of computing devices, such as a cloud-based computing system, a computing system in an internal network, or a computing system in another sort of shared network. Processors of the computing device (1110) and other computing devices of a computing system can be optimized for different types of operations, secure computing tasks, etc. The components shown herein, and their functions, are meant to be examples, and are not meant to limit implementations of the technology described and/or claimed in this document.

The computing device 1110 includes processor(s) 1120, memory device(s) 1130, storage device(s) 1140, and interface(s) 1150. Each of the processor(s) 1120, the memory device(s) 1130, the storage device(s) 1140, and the interface(s) 1150 are interconnected using a system bus 1160. The processor(s) 1120 are capable of processing instructions for execution within the computing device 1110, and can include one or more single-threaded and/or multi-threaded processors. The processor(s) 1120 are capable of processing instructions stored in the memory device(s) 1130 and/or on the storage device(s) 1140. The memory device(s) 1130 can store data within the computing device 1110, and can include one or more computer-readable media, volatile memory units, and/or non-volatile memory units. The storage device(s) 1140 can provide mass storage for the computing device 1110, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 1150 can include various communications interfaces (e.g., USB, Near-Field Communication (NFC), Bluetooth, WiFi, Ethernet, wireless Ethernet, etc.) that can be coupled to the network(s) 1170, peripheral device(s) 1180, and/or data source(s) 1190 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 1150 can include a control interface that receives commands from an input device (e.g., operated by a user) and converts the commands for submission to the processors 1120. The interface(s) 1150 can include a display interface that includes circuitry for driving a display to present visual information to a user. The interface(s) 1150 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 1170 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 1110 can communicate with the peripheral device(s) 1180, the data source(s) 1190, and/or other computing devices over the network(s) 1170. In some implementations, the computing device 1110 can directly communicate with the peripheral device(s) 1180, the data source(s), and/or other computing devices.

The peripheral device(s) 1180 can provide input/output operations for the computing device 1110. Input devices (e.g., keyboards, pointing devices, touchscreens, microphones, cameras, scanners, sensors, etc.) can provide input to the computing device 1110 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 1110 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 1190 can provide data for use by the computing device 1110, and/or can maintain data that has been generated by the computing device 1110 and/or other devices (e.g., data collected from sensor devices, data aggregated from various different data repositories, etc.). In some implementations, one or more data sources can be hosted by the computing device 1110 (e.g., using the storage device(s) 1140). In some implementations, one or more data sources can be hosted by a different computing device. Data can be provided by the data source(s) 1190 in response to a request for data from the computing device 1110 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 1190a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 1190b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 1190c. The machine learning system(s) 1190c, for example, can be used to analyze data from various sources (e.g., data provided by the computing device 1110, data from the data store(s) 1190a, data from the blockchain(s) 1190b, and/or data from other data sources), to identify patterns in the data, and to draw inferences from the data patterns. In general, training data 1192 can be provided to one or more machine learning algorithms 1194, and the machine learning algorithm(s) can generate a machine learning model 1196. Execution of the machine learning algorithm(s) can be performed by the computing device 1110, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer-or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

1. A system for purchasing and activating a decoupled gift card in a retail store, the system comprising:
a first gift card component of a first type, wherein the first gift card component includes a first identifier;
a second gift card component of a second type that is different from the first type, wherein the second gift card component is separate from the first gift card component and includes a second identifier, wherein the second gift card component is configured to be attached to the first gift card component to form a decoupled gift card that is purchasable during a checkout process;
a point of sale (POS) terminal configured to scan the first identifier and the second identifier during the checkout process; and
a remote computer system in network communication with the POS terminal and configured to activate the decoupled gift card while the checkout process is performed at the POS terminal, wherein the remote computer system is configured to perform operations comprising:
receiving, from the POS terminal, the scanned identifiers for the decoupled gift card;
identifying a gift card number corresponding to the first scanned identifier;
identifying an access token corresponding to the second scanned identifier;
associating the gift card number with the access token to activate the decoupled gift card; and
transmitting, to the POS terminal, an indication that the decoupled gift card has been activated,
wherein the POS terminal is configured to complete the checkout process for purchasing the activated decoupled gift card.

2. The system of claim 1, wherein:
the first identifier comprises a barcode that points to the gift card number that is maintained in a data entry of a data table in a data store, wherein the data entry corresponding to the gift card number includes an indication that the first gift card component has an inactive status, and
the second identifier comprises a barcode that points to the access token that is maintained in a data entry of a data table in a data store, wherein the data entry corresponding to the access token includes (i) an indication that the second gift card component has an inactive status and (ii) the access code.

3. (canceled)

4. The system of claim 1, wherein the checkout process is performed at a first retail store, and wherein the decoupled gift card is used during a subsequent checkout process at a second retail store.

5. The system of claim 4, wherein the first retail store and the second retail store are part of a same retailer network.

6. The system of claim 4, wherein the first retail store and the second retail store are part of different retailer networks.

7. The system of claim 1, wherein the first gift card component comprises a physical gift card that is associated with a third party retail store.

8. The system of claim 7, wherein the third party retail store is different than a retail store where the checkout process is performed.

9. The system of claim 7, wherein the third party retail store is the same as the retail store where the checkout process is performed.

10. The system of claim 1, wherein the first gift card component comprises a physical gift card that, once activated, is useable in any retail network.

11. The system of claim 1,
wherein a mobile device of a user is configured to communicate with the remote computer system to redeem the decoupled gift card,
wherein the remote computer system is further configured to perform operations comprising:
receiving a request from the mobile device for a digital gift card, wherein the request comprises the gift card number of the decoupled gift card;
identifying an association between the gift card number of the decoupled gift card and the digital gift card; and
transmitting information that includes the digital gift card to the mobile device of the user, wherein the transmitted information comprises at least an access code for the digital gift card.

12-20. (canceled)
